(19) United States
(12) Patent Application Publication
(10) Pub. No.: US 2024/0250272 A1
(43) Pub. Date: Jul. 25, 2024

(54) PROCESS FOR THE MANUFACTURE OF A MEMBRANE ELECTRODE ASSEMBLY COMPONENT AND MEMBRANE ELECTRODE ASSEMBLY COMPONENT OBTAINABLE THEREBY

(71) Applicants: W. L. Gore & Associates, Inc., Newark, DE (US); W. L. Gore & Associates G.K., Tokyo (JP); W. L. Gore & Associates GmbH, Putzbrunn (DE)

(72) Inventors: Mark D. Edmundson, Rancho Palos Verdes, CA (US); Amr Mahmoud Hamdy Kobaisy Ali, Putzbrunn (DE); Masashi Maruyama, Tokyo (JP); Masaki Tani, Tokyo (JP)

(21) Appl. No.: 18/422,088

(22) Filed: Jan. 25, 2024

Related U.S. Application Data
(60) Provisional application No. 63/481,393, filed on Jan. 25, 2023.

(51) Int. Cl. H01M 4/88; H01M 4/92; H01M 8/10; H01M 8/1004; H01M 8/1039

(52) U.S. Cl. CPC H01M 4/8882; H01M 4/8892; H01M 4/8896; H01M 4/926; H01M 8/1004; H01M 8/1039; H01M 2008/1095

(57) ABSTRACT

There is provided a process for the manufacture of a membrane electrode assembly, a membrane electrode assembly obtainable by such a process, and a fuel cell comprising such a membrane electrode assembly. The electrode is provided by applying a layer of a first electrode first composition on an electrolyte membrane and a layer of a first electrode second composition to the same side of the electrolyte membrane as the first electrode first composition and then heating. The weight ratio of ion exchange material to catalyst in the first electrode first composition is greater than the weight ratio of ion exchange material to first catalyst in the first electrode second composition.

### CROSS-REFERENCE TO RELATED APPLICATION

This application claims the benefit of Provisional Application No. 63/481,393, filed Jan. 25, 2023, which is incorporated herein by reference in its entirety for all purposes.

### FIELD OF THE INVENTION

This disclosure relates to a process for the manufacture of a membrane electrode assembly (MEA) component or a MEA for electrochemical devices, such as for fuel cells, particularly for polymer electrolyte membrane (PEM) fuel cells. Also provided is a membrane electrode assembly component, a membrane electrode assembly and a fuel cell obtainable or obtained by the disclosed process.

### BACKGROUND

A Membrane Electrode Assembly (MEA) is a core component of an electrochemical device and is the location where the electrochemical reactions take place. In fuel cells, these electrochemical reactions generate power. A typical MEA comprises an electrolyte, such as a polymer electrolyte membrane (PEM), and two electrodes comprising catalyst (i.e., the anode and the cathode), which are attached to opposite sides of the electrolyte in a multi-layer assembly. Additionally, the MEA may also include gas diffusion layers (GDLs), which are attached to the outer surfaces of each electrode, opposite to those surfaces in contact with the electrolyte. The GDLs are typically comprised of carbon paper. If two GDLs are present with one attached to each electrode, then the final MEA is considered a multi-layer, e.g. five-layer, assembly including a first layer of GDL, an anode (i.e. electrode), an electrolyte (which may contain one or more layers of electrolyte), a cathode (i.e. electrode) and another, second, layer of GDL.

Typically the electrolyte and GDLs have sufficient mechanical integrity to be self-supporting, but the electrodes do not. Therefore each electrode is typically formed on a substrate which may be the electrolyte, a GDL, or a releasable support layer. The layers of the MEA are then bonded together with heat and/or pressure as needed to form a multi-layer assembly.

The electrolyte, such as a PEM, separates two reactants, such as reactant gas streams. In a fuel cell, on the anode side of the MEA, a fuel, e.g., hydrogen gas, is oxidized to separate the electrons and protons. The cell is designed so that the electrons travel through an external circuit while the protons migrate through the electrolyte. On the cathode side the electrons and protons react with an oxidizing agent (i.e., oxygen or air) to produce water and heat. In this manner, an electrochemical potential is maintained and current can be drawn from the fuel cell to perform useful work.

There are various established techniques for forming the electrodes on an electrolyte and/or bonding the electrodes to other layers of the MEA. However, each technique has its own problems. In one known method, the electrodes are coated onto a releasable support layer and then laminated to an electrolyte, such as a PEM. However, this method is inefficient and costly, requiring the initial manufacture of an electrode on a releasable support layer and then the lamination of the electrode on the electrolyte and the removal of the releasable support layer whilst the electrode must be retained on the electrolyte.

More recently, this addition of an electrode to an electrolyte has been streamlined by coating liquid electrode compositions directly onto the electrolyte, such as a PEM, and drying the composition to form the electrode. However, coating the electrode composition directly on the electrolyte can produce an electrode with undesirable properties. The coated liquid electrode compositions comprise catalyst, ion exchange material (IEM) and liquid carrier, such as water and/or alcohol. Upon drying to provide an electrode, the liquid carrier evaporates from the surface of the coated liquid electrode. The evaporation of the liquid carrier can increase the capillary stress of the liquid, which can lead to cracking in the dried electrode. In addition, direct contact of the electrolyte with the liquid carrier of the coated liquid electrode can induce the swelling of the electrolyte, which may also produce cracking of the dried electrode as the electrolyte expands from contact with the liquid carrier and then contracts upon removal of the liquid carrier by evaporation. The cracking of the dry electrode can lead to a reduction in the performance of the electrochemical device containing such an MEA, for instance a fuel cell. Such a performance reduction may include a voltage drop (also known as over voltage) in the mass transport region of operation, for example in a fuel cell, particularly under wet conditions.

It will be apparent that an MEA manufactured by the lamination of a dried electrode carried on a releasable support to an electrolyte does not suffer from such problems because the coated liquid electrode composition comprising the liquid carrier is coated onto a releasable support and dried to form the dried electrode before the dried electrode is laminated to an electrolyte. This means that the liquid carrier is not present in any substantial amount when the dried electrode is contacted with the electrolyte.

Therefore, the provision of MEAs by direct coating of the electrode composition on the electrolyte may be limited by reduced performance. Accordingly, a need exists for processes for the manufacture of an MEA by direct coating of the electrode composition which provides an MEA with improved performance.

### SUMMARY

This disclosure addresses the problems mentioned above. In a first aspect, there is provided a process for the manufacture of a membrane electrode assembly component, said process comprising at least the steps of:
providing an electrolyte membrane, a first electrode first composition, and a first electrode second composition;
the first electrode first composition comprising ion exchange material, liquid carrier and first catalyst comprising a first catalytic component and a first catalyst support,
the first electrode second composition comprising ion exchange material, liquid carrier and first catalyst comprising a first catalytic component and a first catalyst support, ion exchange material and liquid carrier, wherein
the weight ratio of ion exchange material to first catalyst support in the first electrode first composition is greater than the weight ratio of ion exchange material to first catalyst support in the first electrode second composition;
applying the first electrode first composition to a first side of the electrolyte membrane to provide a layer of the first electrode first composition having a first side in contact with the first side of the electrolyte membrane;
applying the first electrode second composition to the same side of the electrolyte membrane as the first electrode first composition to provide a layer of the first electrode second composition;
heating the layer of the first electrode first composition and the layer of the first electrode second composition on the electrolyte membrane to remove liquid carrier from the first electrode first composition and the first electrode second composition to provide a first electrode on the electrolyte membrane, wherein the first electrode comprises the first catalyst and the ion exchange material, to produce a membrane electrode assembly component comprising the first electrode and the electrolyte membrane.

The process described lays down an electrode, such as an anode or a cathode, in at least two deposition steps, in which the electrode composition applied is different in each step. In particular, the weight ratio of the ion exchange material to catalyst support in the electrode first composition deposited in the first step, which is the composition which contacts the electrolyte, is higher than the weight ratio of the ion exchange material to catalyst support in the electrode second composition that is deposited in the second step, for a given electrode. This difference in weight ratios provides a layer of electrode first composition, which is in contact with the electrode layer, which has a higher concentration of ion exchange material compared to that of the subsequent electrode second composition, resulting in a membrane electrode assembly with improved performance. Such improved performance mitigates any voltage drop (also known as over voltage) in the mass transport region of the electrochemical device like a fuel cell, particularly under wet conditions.

The heating of the layer of the first electrode first composition and the layer of the first electrode second composition on the electrolyte membrane to remove liquid carrier from the first electrode first composition and the first electrode second composition may be carried out simultaneously i.e. there is no intermediate heating step between the application of the first electrode first composition and the application of the first electrode second composition. The first electrode formed by the heating step is a dry first electrode. Thus, the heating of the layer of the first electrode first composition and the layer of the first electrode second composition on the electrolyte membrane to remove liquid carrier from the first electrode first composition and the first electrode second composition can be carried out in a single heating step. When both layers of first electrode first composition and first electrode second composition are present in an undried state, providing a lower concentration of ion exchange material in the layer of the first electrode second composition mitigates the diffusion of ion exchange material to the surface of the first electrode, and therefore into the first electrode second composition during drying.

Thus, in one embodiment, the step of applying of the first electrode second composition applies the first electrode second composition to a second side of the layer of the first electrode first composition opposite to that of the first side of the layer of the first electrode first composition (which is in contact with the first side of the electrolyte membrane) to provide a layer of the first electrode second composition having a first side in contact with the second side of the layer of the first electrode first composition. The heating the layer of the first electrode first composition and the layer of the first electrode second composition on the electrolyte membrane to remove liquid carrier from the first electrode first composition and the first electrode second composition therefore provides a first electrode on the electrolyte membrane is a single heating step.

Alternatively, the heating of the layer of the first electrode first composition on the electrolyte membrane may be a first heating step to remove liquid carrier from the first electrode first composition to provide a first electrode first layer on the electrolyte membrane, for instance in contact with the first side of the electrolyte membrane. The first electrode first layer may be substantially dry i.e. substantially free of liquid carrier. The first heating step can be carried out before the first electrode second composition is applied to the same side of the electrolyte membrane as the first electrode first composition. Thus, the step of applying the first electrode second composition to the same side of the electrolyte membrane as the first electrode first composition applies the first electrode second composition to a second side of the first electrode first layer opposite to that of a first side of the first electrode first layer which is in contact with the first side of the electrolyte membrane. This provides a layer of the first electrode second composition having a first side in contact with the second side of the first electrode first layer. As the first electrode first layer is substantially free of liquid carrier, the ion exchange material in that layer cannot move freely. The weight ratio of ion exchange material to first catalyst support in the first electrode first layer therefore remains greater than the weight ratio of ion exchange material to first catalyst support in the first electrode second composition. The heating of the layer of the first electrode second composition is thus a second heating step to remove liquid carrier from the first electrode second composition to provide a first electrode second layer on the second side of the first electrode first layer to provide a first electrode comprising the first electrode first layer and the first electrode second layer. The weight ratio of ion exchange material to first catalyst support in the first electrode first layer is therefore greater than the weight ratio of ion exchange material to first catalyst support in the first electrode second layer.

In one embodiment, the first electrode is a cathode or an anode.

In another embodiment, the process is a process for the manufacture of a membrane electrode assembly, the process further comprising the steps of:
providing a second electrode first composition, and a second electrode second composition;
the second electrode first composition comprising liquid carrier, ion exchange material and second catalyst comprising second catalytic component and second catalyst support,
the second electrode second composition comprising liquid carrier, ion exchange material and second catalyst comprising second catalytic component and second catalyst support, wherein
the weight ratio of ion exchange material to second catalyst support in the second electrode first composition is greater than the weight ratio of ion exchange material to second catalyst support in the second electrode second composition;
applying the second electrode first composition to a second side of the electrolyte membrane, the second side of the electrolyte membrane opposite to that of the first side of the electrolyte membrane, to provide a layer of the second electrode first composition having a first side in contact with the second side of the electrolyte membrane;
applying the second electrode second composition to the same side of the electrolyte membrane as the second electrode first composition to provide a layer of the second electrode second composition;
heating the layer of the second electrode first composition and the layer of the second electrode second composition on the electrolyte membrane to remove liquid carrier from the second electrode first composition and second electrode second composition to provide a second electrode on the electrolyte membrane, wherein the second electrode comprises the second catalyst and the ion exchange material, to produce a membrane electrode assembly comprising, in order, the first electrode, the electrolyte membrane, and the second electrode.

The heating of the layer of the second electrode first composition and the layer of the second electrode second composition on the electrolyte membrane to remove liquid carrier from the second electrode first composition and the second electrode second composition may be carried out simultaneously i.e. there is no intermediate heating between the application of the second electrode first composition and the application of the second electrode second composition. The second electrode formed by the heating step is a dry second electrode. Thus, the heating of the layer of the second electrode first composition and the layer of the second electrode second composition on the electrolyte membrane to remove liquid carrier from the second electrode first composition and the second electrode second composition can be carried out in a single heating step. When both layers of second electrode first composition and second electrode second composition are present in an undried state, providing a lower concentration of ion exchange material in the layer of the second electrode second composition mitigates the diffusion of ion exchange material to the surface of the second electrode, and therefore into the second electrode second composition during drying.

Thus, in one embodiment, the step of applying of the second electrode second composition applies the second electrode second composition to a second side of the layer of the second electrode first composition opposite to that of the first side of the layer of the second electrode first composition. This provides a layer of the second electrode second composition having a first side in contact with the second side of the layer of the second electrode first composition. The heating the layer of the second electrode first composition and the layer of the second electrode second composition on the electrolyte membrane to remove liquid carrier from the second electrode first composition and the second electrode second composition therefore provides a second electrode on the electrolyte membrane is a single heating step.

Alternatively, the heating of the layer of the second electrode first composition on the electrolyte membrane may be a first heating step to remove liquid carrier from the second electrode first composition to provide a second electrode first layer on the electrolyte membrane, for instance in contact with the second side of the electrolyte membrane. The first electrode first layer may be substantially dry i.e. substantially free of liquid carrier. The first heating step can be carried out before the second electrode second composition is applied to the same side of the electrolyte membrane as the second electrode first composition. Therefore, applying the second electrode second composition to the same side of the electrolyte membrane as the second electrode first composition applies the second electrode second composition to a second side of the second electrode first layer opposite to that of a first side of the second electrode first layer which is in contact with the second side of the electrolyte membrane. This provides a layer of the second electrode second composition having a first side in contact with the second side of the second electrode first layer. As the second electrode first layer is substantially free of liquid carrier, the ion exchange material in that layer cannot move freely. The weight ratio of ion exchange material to second catalyst support in the second electrode first layer therefore remains greater than the weight ratio of ion exchange material to second catalyst support in the second electrode second composition. The heating of the layer of the second electrode second composition is thus a second heating step to remove liquid carrier from the second electrode second composition to provide a second electrode second layer on the second side of the second electrode first layer to provide a second electrode comprising the first electrode first layer and first electrode second layer. The weight ratio of ion exchange material to second catalyst support in the second electrode first layer is therefore greater than the weight ratio of ion exchange material to second catalyst support in the second electrode second layer.

In another embodiment, the second electrode is a cathode or an anode. For instance, when the first electrode is an anode, the second electrode is a cathode. When the first electrode is a cathode, the second electrode is an anode.

In another embodiment of the process, the difference between the weight ratio of the ion exchange material to the catalyst support, such as the first catalyst support or any second catalyst support, in the electrode first composition and the weight ratio of the ion exchange material to the catalyst support, such as the first catalyst support or any second catalyst support, in the electrode second composition of an electrode, such as the first electrode or any second electrode, is at least 0.4. This difference may be at least 0.5. This difference may be at least 0.6. This difference may be at least 0.7. This difference may be at least 0.8. This difference may be the same or different for the electrode first and second compositions of the first electrode and any second electrode.

Preferably, the difference between the weight ratio of the ion exchange material to the catalyst support, such as the first catalyst support or any second catalyst support, in the electrode first composition and the weight ratio of the ion exchange material to the catalyst support, such as the first catalyst support or any second catalyst support, in the electrode second composition of an electrode, such as the first electrode or any second electrode, is preferably at least 0.9. This difference may be at least 1.0. This difference may be at least 1.1. This difference may be at least 1.2.

Preferably, the difference between the weight ratio of the ion exchange material to the catalyst support, such as the first catalyst support or any second catalyst support, in the electrode first composition and the weight ratio of the ion exchange material to the catalyst support, such as the first catalyst support or any second catalyst support, in the electrode second composition of an electrode, such as the first electrode or any second electrode, is less than 2. This difference may be less than 1.9. This difference may be less than 1.8. This difference may be preferable less than 1.7. This difference may be less than 1.6. This difference may be less than 1.5. This difference may be the same or different for the electrode first and second compositions of the first electrode and any second electrode.

Preferably, the difference between the weight ratio of the ion exchange material to the catalyst support, such as the first catalyst support or any second catalyst support, in the electrode first composition and the weight ratio of the ion exchange material to the catalyst support, such as the first catalyst support or any second catalyst support, in the electrode second composition of an electrode, such as the first electrode or any second electrode, is in the range of from 0.4 to less than 2. This difference may be in the range of from 0.5 to less than 1.9. This difference may be in the range of from 0.6 to less than 1.8. This difference may be in the range of from 0.7 to less than 1.8. This difference may be preferably in the range of from 0.8 to less than 1.7. This difference may be preferably in the range of from 0.9 to less than 1.5. This difference may be the same or different for the electrode first and second compositions of the first electrode and any second electrode.

In another embodiment of the process, the weight ratio of the ion exchange material to the catalyst support, such as the first catalyst support or any second catalyst support, in the electrode first composition is in the range of from 1.4 to 2.4 and the weight ratio of the ion exchange material to the catalyst support, such as the first catalyst support or any second catalyst support, in the electrode second composition is in the range of from 0.4 to less than 1.4 for an electrode, such as the first electrode or any second electrode. These weight ratios may be the same or different for the electrode first and second compositions of the first electrode and any second electrode.

Preferably, the weight ratio of the ion exchange material to the catalyst support, such as the first catalyst support or any second catalyst support, in the electrode first composition is in the range of from 1.6 to 2.1 and the weight ratio of the ion exchange material to the catalyst support, such as the first catalyst support or any second catalyst support, in the electrode second composition is in the range of from 0.5 to 1.2 for an electrode, such as the first electrode or any second electrode.

In another embodiment of the process, the average of the weight ratio of the ion exchange material to the catalyst support, such as the first catalyst support or any second catalyst support, in the layer of electrode first composition and the weight ratio of the ion exchange material to the catalyst support, such as the first catalyst support or any second catalyst support, in the layer of electrode second composition, is from 1.0 to 1.6, preferably from 1.1 to 1.5, for the first electrode or any second electrode. This average may be the same or different for the layers of electrode first and second compositions of the first electrode and any second electrode.

In another embodiment of the process, the steps of applying the electrode first composition and the electrode second composition, such as for the first electrode and any second electrode, are independently selected from slot die coating, slide die coating, curtain coating, gravure coating, reverse roll coating, spray coating, knife-over-roll coating, and dip coating. This application step may be the same or different for the first electrode and any second electrode.

In another embodiment of the process, the step of heating the layers of electrode first composition and electrode second composition, either simultaneously or sequentially, comprises drying at a temperature in the range of from 60 to 160° C., such as for the first electrode or any second electrode. Preferably, the temperature is in the range of from 100 to 150° C. This temperature may be the same or different for the electrode first composition and electrode second composition of the first electrode and any second electrode, and may be the same or different between the electrode first and second compositions of the first and second electrodes.

In another embodiment of the process, one or both of the first electrode and any second electrode may be electronically conductive. One or both of the first electrode and any second electrode may further comprise a conductive layer, such as a conductive layer comprising graphite.

In another embodiment of the process, the first electrode comprises a first side and an opposing second side. The first side of the first electrode is in contact with the first side of the electrolyte membrane. In an optional step, a first releasable support layer may be applied to the second side of the first electrode after heating the layer of the first electrode first composition and the layer of the first electrode second composition on the electrolyte membrane to remove liquid carrier, but before the application of the second electrode first composition to the second side of the electrolyte membrane. The first releasable support layer protects the second surface of the first electrode and provides support and stability to the MEA for subsequent processing steps.

In one embodiment the first releasable support layer comprises a single layer or film, formed of a plastics material. The first releasable support layer can be a film or fabric, such as a woven material or a non-woven material, such as a web. The plastics material may be selected from the group comprising polypropylene, polyester, polyethylene (“PE”), polystyrene (“PS”), cyclic olefin copolymer (“COC”), cyclic olefin polymer (“COP”), fluorinated ethylene propylene (“FEP”), perfluoroalkoxy alkanes (“PFAs”), ethylene tetrafluoroethylene (“ETFE”), polyvinylidene fluoride (“PVDF”), polyetherimide (“PEI”), polysulfone (“PSU”), polyethersulfone (“PES”), polyphenylene oxide (“PPO”), polyphenyl ether (“PPE”), polymethylpentene (“PMP”), polyethyleneterephthalate (“PET”), or polycarbonate (“PC”). The first releasable support layer preferably comprises a polyethersulfone (“PES”) film or a polyethyleneterephthalate (“PET”) film. The first releasable support layer may be applied to the second side of the first electrode by a hot roll lamination process.

In another embodiment of the process, the second electrode comprises a first side and an opposing second side. The first side of the second electrode is in contact with the second side of the electrolyte membrane. In an optional step, a second releasable support layer may be applied to the second side of the second electrode after heating the layer of the second electrode first composition and the layer of the second electrode second composition on the electrolyte membrane to remove liquid carrier. The second releasable support layer protects the second surface of the second electrode and provides support and stability to the MEA. The second releasable support layer may be independently selected from those materials discussed previously for the first releasable support layer.

In another embodiment of the process, the liquid carrier comprises water. The water may be present in the electrode first composition of an electrode, such as the first and any second electrode first composition, in an amount greater than 35 wt. % based on a total weight of the ion exchange material and liquid carrier in the electrode first composition. The water may be present in the electrode second composition of an electrode, such as the first and any second electrode composition, in an amount greater than 35 wt. % based on a total weight of the ion exchange material and liquid carrier in the electrode second composition. These amounts may be the same or different for the first catalyst compositions and any second catalyst compositions.

The liquid carrier may further comprise a C₂-C₁₀ alcohol. Preferably, the C₂-C₁₀ alcohol may comprise one or more alcohols selected from the group comprising ethanol, 1-propanol, 2-propanol and 2-methyl-2-propanol. More preferably, the C₂-C₁₀ alcohol is ethanol. The C₂-C₁₀ alcohol may be present in the electrode first composition or electrode second composition of an electrode, such as that of the first or any second electrode, in an amount less than 50 wt. % based on a total weight of the ion exchange material and liquid carrier in the electrode first or second composition. The C₂-C₁₀ alcohol and corresponding amount may be the same or different for the first catalyst composition, such as of the first electrode or any second electrode, and the second catalyst composition, such as of the first electrode or any second electrode.

In another embodiment of the process, the catalyst, such the first catalyst or any second catalyst, may further comprise a catalyst support. The catalyst support may be a carbon particulate. The catalyst support of the first catalyst may be the same as or different to that of any second catalyst.

In another embodiment of the process, the catalytic component, such as the first catalytic component or any second catalytic component, comprises one or more catalytic components. The one or more catalytic components may be selected from the group comprising Pt, Ir, Ni, Co, Pd, Ti, Sn, Ta, Nb, Sb, Pb, Mn, Ru and Fe, their oxides, and mixtures thereof. The one or more first catalytic components comprising the first catalyst may be the same as or different to that of the one of more second catalytic components of any second catalyst. Preferably the one or more first catalytic components of the first catalyst are different from the one or more second catalytic components of any second catalyst.

In another embodiment of the process, the average catalyst loading of an electrode, in terms of the catalytic component, such as the one or more first catalytic components or any one or more second catalytic components, is in the range of from 0.1 to 0.3 mg/cm². Typically, the one or more catalytic components comprise platinum for such a range of catalyst loading. The average catalyst loading of the first electrode may be the same as or different to the catalyst loading of any second electrode.

The catalyst loading, such as that of the first catalyst or any second catalyst, in the electrode first composition and the electrode second composition of an electrode, such as that of the first or any second electrode, may be substantially the same or may be different. The catalyst loading in terms of the catalytic component, such as that of the first catalyst or any second catalyst, in the electrode first composition of an electrode, such as the first or any second electrode, may be in the range of from 0.05 to 0.25 mg/cm² for the electrode first composition after the removal of the liquid carrier. The catalyst loading in terms of the catalytic component, such as that of the first catalyst or any second catalyst, in the electrode second composition of an electrode, such as the first or any second electrode, may be in the range of from 0.15 to 0.45 mg/cm² for the electrode second composition after the removal of the liquid carrier.

In another embodiment of the process, the ion exchange material of the electrode first or second composition, such as that of the first or any second electrode, comprises at least one ionomer. The at least one ionomer may comprise a proton conducting polymer. The proton conducting polymer preferably comprises a perfluorosulfonic acid. The at least one ionomer may have a density of not lower than about 1.9 g/cc at 0% relative humidity. The ionomer may be present in the electrode first composition or electrode second composition of an electrode, such as that of the first electrode or any second electrode, in an amount less than 50 wt. % based on a total weight of the ionomer and liquid carrier in the electrode first composition or electrode second composition. The amount of ionomer in the electrode first composition of an electrode, such as the first electrode or any second electrode, may be the same as or different to the amount of ionomer in the electrode second composition of the same electrode. The amount of ionomer in the electrode second composition of the first electrode may be the same as or different to the amount of ionomer in the electrode second composition of any second electrode. Similarly, the

In another embodiment of the process, the electrolyte membrane comprises an ion exchange material. The ion exchange material of the electrolyte membrane may have the same composition as the ion exchange material of the first electrode and/or any second electrode i.e. the ion exchange materials may have the same chemical composition and properties. Alternatively, the ion exchange material of the electrolyte membrane may have a different composition than the ion exchange material of the first electrode and/or any second electrode i.e. the ion exchange materials may have different chemical compositions and/or properties etc.

The ion exchange material of the electrolyte membrane may be a polymer electrolyte membrane. The polymer electrolyte membrane may comprise at least one ionomer. The at least one ionomer of the polymer electrolyte membrane may have a density not lower than about 1.9 g/cc at 0% relative humidity. The at least one ionomer of the polymer electrolyte membrane may comprise a proton conducting polymer. The proton conducting polymer of the polymer electrolyte membrane may comprise perfluorosulfonic acid. Alternatively the proton conducting polymer may comprise a hydrocarbon.

The polymer electrolyte membrane may be a reinforced polymer electrolyte membrane. The reinforced polymer electrolyte membrane may further comprise a microporous support. The microporous support may be a polymeric matrix into which the ion exchange material is embedded to support the ion exchange material or ionomer, adding structural integrity and durability to the resulting reinforced polymer electrolyte membrane. The ion exchange material may be at least partially imbibed into the microporous support. The microporous support may be fully imbibed with ion exchange material. Such a microporous support fully imbibed with ion exchange material may be rendered occlusive.

As used herein, a portion of the microporous support is referred to as rendered “occlusive” or “occluded” when the interior volume of that portion has structures that are characterized by low volume of voids, such as less than 10% by volume, and is highly impermeable to gas, as indicated by Gurley numbers larger than 10000 s. Conversely, the interior volume of a portion of the microporous support is referred to as “non-occlusive” or “non-occluded” when the interior volume of that portion has structures that are characterized by large volume of voids, for instance more than or equal to 10% by volume, and is permeable to gas, as indicated by Gurley numbers less than or equal to 10000 s.

The microporous support of the polymer electrolyte membrane may comprise at least one fluorinated polymer. The at least one fluorinated polymer may be selected from the group comprising polytetrafluoroethylene (PTFE), poly(ethylene-co-tetrafluoroethylene) (EPTFE), expanded polytetrafluoroethylene (ePTFE), polyvinylidene fluoride (PVDF), expanded polyvinylidene fluoride (ePVDF), expanded poly(ethylene-co-tetrafluoroethylene) (eEPTFE) and mixtures thereof. The fluorinated polymer is preferably expanded polytetrafluoroethylene (ePTFE).

Alternatively, the microporous support of the polymer electrolyte membrane may comprise at least one hydrocarbon polymer. The at least one hydrocarbon polymer may be selected from the group comprising polyethylene, polypropylene, polycarbonate, polystyrene, and mixtures thereof.

In another embodiment, the electrolyte membrane may comprise a plurality of electrolyte layers. For instance, a reinforced polymer electrolyte membrane comprising a microporous support may further comprise one or more additional layers of microporous support and/or one or more layers of ion exchange material which are not imbibed into a microporous supporti.e. one or more layers of unreinforced ion exchange material or unsupported polymer electrolyte membrane. The one or more layers of ion exchange material which are not imbibed into a microporous support may lie on one or both opposing sides of a microporous support. Alternatively the electrolyte membrane may comprise a plurality of layers of ion exchange material which are not imbibed into a microporous support i.e. a plurality of layers of unreinforced polymer electrolyte membrane. Thus, the electrolyte membrane first and second surfaces onto which the electrode first compositions are applied may be a layer of reinforced polymer electrolyte membrane or a layer of unreinforced polymer electrolyte membrane.

In another embodiment of the process, the first electrode has a first side and an opposite second side, the first side of the first electrode in contact with the first side of the electrolyte membrane, and wherein the process further comprises the steps of:
providing a first gas diffusion layer; and
applying the first gas diffusion layer to the second side of the first electrode to provide a membrane electrode assembly comprising, in order, the first gas diffusion layer, the first electrode and the electrolyte membrane.

In another embodiment, when the second surface of the first electrode is protected by a first releasable support layer, the process further comprises the step of separating the first releasable support layer from the first electrode before applying the first gas diffusion layer to the second side of the first electrode.

The steps of applying a first gas diffusion layer to the first electrode may also be applied when a second electrode is present on the electrolyte membrane, such that a membrane electrode assembly is provided comprising, in order, the first gas diffusion layer, the first electrode, the electrolyte membrane, and the second electrode.

In another embodiment of the process, the second electrode may have a first side and an opposite second side, the first side of the second electrode in contact with the second side of the electrolyte membrane, and the process may further comprise the steps of:
providing a second gas diffusion layer; and
applying the second gas diffusion layer to the second side of the second electrode to provide a membrane electrode assembly comprising, in order, the first gas diffusion layer, the first electrode, the electrolyte membrane, the second electrode and the second gas diffusion layer.

In another embodiment, when the second surface of the second electrode is protected by a second releasable support layer, the process further comprises the step of separating the second releasable support layer from the second electrode before applying the second gas diffusion layer to the second side of the second electrode.

In another embodiment, the first gas diffusion layer and any second gas diffusion layer may comprise a porous carbon particle layer, such as microporous carbon paper.

In a second aspect, there is provided a membrane electrode assembly obtainable or obtained by the process according to the first aspect and any of its embodiments, or a combination of such embodiments. The membrane electrode assembly may be a fuel cell membrane-electrode assembly.

In a third aspect, there is provided a fuel cell obtainable or obtained by the process according to the first aspect and any of its embodiments, or a combination of such embodiments.

### BRIEF DESCRIPTION OF THE FIGURES

In the Figures, identical reference numerals have been used for the same or equivalent features of the membrane electrode assemblies disclosed herein.

FIG. 1 shows a schematic diagram of a process for applying first electrode first and second compositions to an electrolyte membrane.

FIG. 2 shows a schematic diagram of a process for applying second electrode first and second compositions to an electrolyte membrane having a first electrode on its opposite side.

FIG. 3 shows a schematic diagram of a membrane electrode assembly produced according to an embodiment of the described process, the MEA comprising in order, a first electrode, an electrolyte membrane and a second electrode.

FIG. 4 shows a schematic diagram of a membrane electrode assembly produced according to an embodiment of the described process, the MEA comprising in order, a first gas diffusion layer, a first electrode, an electrolyte membrane, a second electrode and a second gas diffusion layer.

FIG. 5 shows a plot of cell voltage versus current density for a membrane electrode assembly of the embodiment of Example 1 determined at a temperature of 80° C. and a relative humidity (RH) of 112% in comparison to a membrane electrode assembly in which only a single layer of an electrode composition is applied as the cathode.

FIG. 6 shows a plot of cell voltage versus current density for a membrane electrode assembly of the embodiment of Example 1 determined at a temperature of 70° C. and a relative humidity (RH) of 170% in comparison to a membrane electrode assembly in which only a single layer of an electrode composition is applied as the cathode.

FIG. 7 shows a plot of cell voltage versus current density for a membrane electrode assembly of the embodiment of Example 2 determined at a temperature of 80° C. and a relative humidity (RH) of 112% in comparison to a membrane electrode assembly in which only a single layer of an electrode composition is applied and a membrane electrode assembly in which only the electrode first composition is applied as the cathode.

FIG. 8 shows a plot of cell voltage versus current density for a membrane electrode assembly of the embodiment of Example 2 determined at a temperature of 80° C. and a relative humidity (RH) of 112% in comparison to a membrane electrode assembly in which only a single layer of an electrode composition is applied and a membrane electrode assembly in which only the electrode first composition is applied as the cathode.

### DETAILED DESCRIPTION

It will be apparent that various aspects of the present disclosure can be realized by any number of processes and apparatus configured to perform the intended functions. It should also be noted that the accompanying Figures referred to herein are not necessarily drawn to scale, and may be exaggerated to illustrate various aspects of the present disclosure, and in that regard, the figures should not be construed as limiting. Directional references such as “up,” “down,” “top,” “left,” “right,” “front,” and “back,” among others are intended to refer to the orientation as illustrated and described in the figure (or figures) to which the components and directions are referencing. Identical reference numerals in different Figures refer to identical features.

It is to be noted that all ranges described herein are exemplary in nature and include any and all values in between. The terms “substantially,” “approximately” and “about” are defined as being largely but not necessarily wholly what is specified (and include wholly what is specified) as understood by one of ordinary skill in the art. In any disclosed embodiment, the term “substantially,” “approximately,” or “about” may be substituted with “within [a percentage] of” what is specified, where the percentage includes 0.1, 1, 5, or 10 percent, typically 10 percent. For a lower limit this represents the lower limit value minus the percentage of the lower limit and for an upper limit this represents the limit value plus the percentage of the lower limit.

In addition, all references cited herein are incorporated by reference in their entireties.

A membrane electrode assembly (MEA) component is comprised of an electrolyte membrane and an electrode. Thus, the MEA component may be a two-layer assembly, having layers placed adjacent to one another such as electrode (such as anode or cathode)-electrolyte membrane. As used herein, an electrolyte membrane is sheet-like structure such that two of the three orthogonal dimensions defining the membrane are larger than the third dimension, which represents the membrane thickness. Typically the thickness of the membrane is 0.5, 0.2 or 0.1 times or less the size of the other two orthogonal dimensions. Preferably, the thickness of the membrane is at least an order of magnitude smaller than the other two orthogonal dimensions. The following discussion uses the terms “electrolyte membrane” and “electrolyte” interchangeably. The electrolyte membrane may be a polymer electrolyte membrane (PEM) and the electrode may be one of an anode or a cathode. Typically a membrane electrode assembly (MEA) is comprised of an electrolyte membrane with an anode electrode on one side and a cathode electrode on the other side i.e. a membrane electrode assembly component with a second electrode such that the first and second electrodes are on opposing sides of the electrolyte membrane. Thus, the MEA may be a three-layer assembly, having the layers placed adjacent to each other as anode-electrolyte membrane-cathode. Additionally, the MEA may also include Gas Diffusion Layers (GDLs) attached to the side of each electrode opposite to that side in contact with the electrolyte membrane. If GDLs are attached to both electrodes then the final MEA is considered a five-layer assembly, having the layers placed adjacent to each other as GDL-Anode-Electrolyte membrane-Cathode-GDL in the final MEA.

In one known method, an MEA is made by first preparing an electrode composition comprising ion exchange material, catalyst, and liquid carrier. The electrode composition is then coated and substantially dried on an electrolyte, such as an electrolyte membrane. However, it has been discovered that coating the electrode composition directly on the electrolyte can produce an electrode with an undesirably large concentration gradient of ion exchange material in the dried electrode. A relatively lower concentration of ion exchange material is present in the portion of the dried electrode nearer the electrolyte and a relatively higher concentration of ion exchange material is present in the portion of the dried electrode nearer to the electrode surface, which is the surface opposite the surface in contact to the electrolyte layer.

It has now been discovered that if the electrode composition is applied in two layers, each from a different electrode composition, with the layer of electrode composition in contact with the electrolyte membrane having a weight ratio of ion exchange material to first catalyst support in the which greater than the weight ratio of ion exchange material to first catalyst support in the layer of electrode composition applied on top of it, the concentration gradient across the electrode after drying can be mitigated. Fuel cells containing such MEAs have improved performance, particularly in their mass transport region of operation, especially under wet conditions.

### Processes for the Manufacture of a Membrane Electrode Assembly

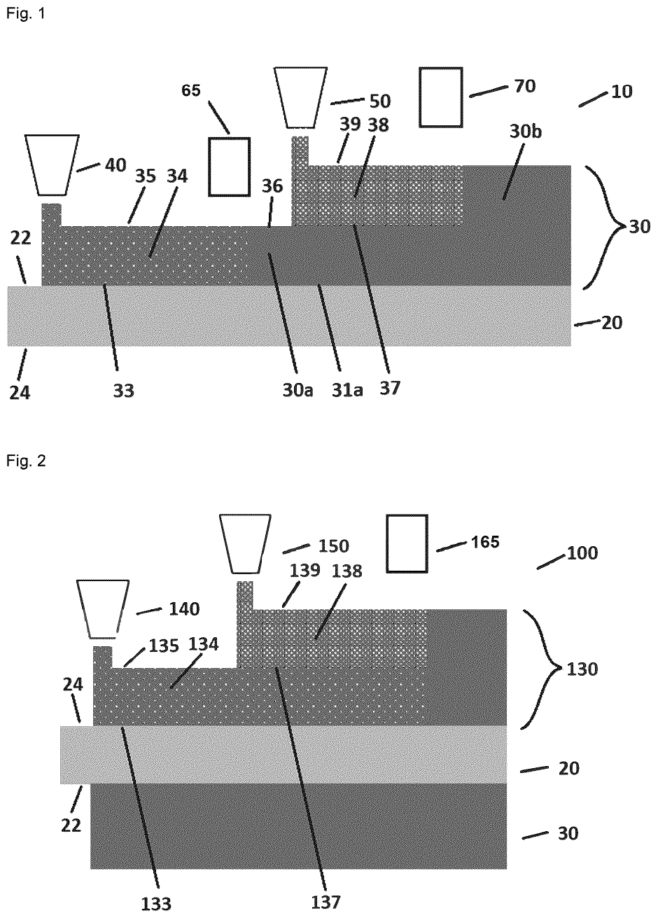

The disclosed processes include steps as described below and illustrated in the FIGS. 1 and 2. Although described as sequential steps for the purposes of explanation, this disclosure contemplates that in practice the steps may be performed in any order or simultaneously unless stated otherwise. For instance, the heating of the layers of electrode first and second compositions of a particular electrode may be carried out at the same time or may comprise intermediate heating steps.

An MEA component or MEA may be produced continuously or discontinuously as described herein. An MEA component or MEA may be continuously produced, for instance using a roll feed and/or roll winder, deposition apparatus, and heating apparatus. The roll feed and/or roll winder may be rollers or alternative means of web conveyance. The deposition apparatus may be a slot die or alternative means of film coating. Each heating apparatus may be a convection oven or alternative means of wet film drying.

Alternatively, the MEA component or MEA may be produced in a discontinuous manner, with the various process steps carried out separately, with optional storage of any intermediate between the process steps. For instance, the first and second electrodes may be applied in separate process lines, with optional intermediate storage of the membrane electrode assembly component comprising the first electrode and the electrolyte membrane, prior to application of any second electrode to provide a MEA.

FIG. 1 shows a schematic process 10 for the manufacture of a MEA component, including application of a layer of a first electrode first composition 34 and a layer of a first electrode second composition 38 to an electrolyte membrane 20 and heating steps to dry the first electrode first composition and second composition 34, 38. The first electrode first composition 34 and first electrode second composition 38 are liquid compositions.

The electrolyte membrane 20 may comprise an ion exchange material. The ion exchange material of the electrolyte membrane may be a polymer electrolyte membrane. The polymer electrolyte membrane may comprise at least one ionomer, such as an ionomer having a density not lower than about 1.9 g/cc at 0% relative humidity. The at least one ionomer of the polymer electrolyte membrane may comprise a proton conducting polymer. The proton conducting polymer of the polymer electrolyte membrane may comprise perfluorosulfonic acid or a hydrocarbon.

The electrolyte membrane 20 may be a reinforced polymer electrolyte membrane comprising a microporous support and an ionomer such as a proton-conducting polymer impregnated in the microporous support as described in Bahar et al, US Patent No. RE 37,307. The ion exchange material may be fully embedded within the microporous support. The ion exchange material may include more than one ion exchange material in the form of a mixture of ion exchange materials.

The electrolyte membrane 20 may include more than one layer of ion exchange material. The layers of ion exchange material may be formed of the same ion exchange material. Alternatively, the layers of ion exchange material may be formed of differention exchange materials. Optionally, at least one of the layers of ion exchange material may comprise a mixture of ion exchange materials. The ion exchange material may include at least one ionomer.

The microporous support may have a first surface and an opposing second surface. The ion exchange material may form a layer on the first surface, on the second surface, or both on the first surface and the second surface. The ion exchange material may be partially embedded within the microporous support leaving a non-occlusive portion of the microporous support closest to the first surface, second surface or both. The non-occlusive portion may be free of any of the ion exchange material. The non-occlusive portion may include a coating of ion exchange material to an internal surface of the microporous support.

The electrolyte membrane 20 may comprise a single microporous support. The electrolyte membrane 20 may comprise more than one microporous support. When the electrolyte membrane 20 comprises at least two microporous supports, the composition of each microporous support may be the same, or it may be different.

The microporous support may be a microporous polymer structure. The microporous polymer structure may comprise at least one fluorinated polymer e.g. a polymeric fluorocarbon material or at least one hydrocarbon polymer e.g. a polymeric hydrocarbon material. The at least one fluorinated polymer may be selected from the group comprising polytetrafluoroethylene (PTFE), poly(ethylene-co-tetrafluoroethylene) (EPTFE), expanded polytetrafluoroethylene (ePTFE), polyvinylidene fluoride (PVDF), expanded polyvinylidene fluoride (ePVDF), expanded poly(ethylene-co-tetrafluoroethylene) (eEPTFE) and mixtures thereof. The at least one fluorinated polymer is preferably an expanded polytetrafluoroethylene (ePTFE) membrane. The at least one hydrocarbon polymer may be selected from the group comprising polyethylene, polypropylene, polycarbonate, polystyrene, and mixtures thereof.

The electrolyte membrane 20 may optionally be provided on a releasable backing layer (not shown in FIG. 1). The electrolyte membrane 20 may have a first side 22 and an opposing second side 24. The second side 24 of the electrolyte membrane 20 may be in contact with the releasable backing layer.

The releasable backing layer can be a film or fabric, such as a woven material or a non-woven material, such as a web. Suitable releasable backing layers may comprise woven materials which may include, for example, scrims made of woven fibers of expanded porous polytetrafluoroethylene; webs made of extruded or oriented polypropylene or polypropylene netting, commercially available from Conwed, Inc. of Minneapolis, Minn.; and woven materials of polypropylene and polyester, from Tetko Inc., of Briarcliff Manor, N.Y. Suitable non-woven materials for the releasable backing layer may include, for example, a spun-bonded polypropylene from Reemay Inc. of Old Hickory, Tenn. Other suitable releasable backing layers can include web of polyethylene (“PE”), polystyrene (“PS”), cyclic olefin copolymer (“COC”), cyclic olefin polymer (“COP”), fluorinated ethylene propylene (“FEP”), perfluoroalkoxy alkanes (“PFAs”), ethylene tetrafluoroethylene (“ETFE”), polyvinylidene fluoride (“PVDF”), polyetherimide (“PEI”), polysulfone (“PSU”), polyethersulfone (“PES”), polyphenylene oxide (“PPO”), polyphenyl ether (“PPE”), polymethylpentene (“PMP”), polyethyleneterephthalate (“PET”), or polycarbonate (“PC”). The releasable backing layer may also include a protective layer, which can include polyethylene (PE), polystyrene (“PS”), cyclic olefin copolymer (“COC”), cyclic olefin polymer (“COP”), fluorinated ethylene propylene (“FEP”), perfluoroalkoxy alkanes (“PFAs”), ethylene tetrafluoroethylene (“ETFE”), polyvinylidene fluoride (“PVDF”), polyetherimide (“PEI”), polysulfone (“PSU”), polyethersulfone (“PES”), polyphenylene oxide (“PPO”), polyphenyl ether (“PPE”), polymethylpentene (“PMP”), polyethyleneterephthalate (“PET”), or polycarbonate (“PC”). The releasable backing layer optionally may include a reflective layer that includes a metal substrate (e.g., an aluminum substrate). Preferably, the releasable backing layer comprises a polymer sheet substrate (obtained from DAICEL VALUE COATING LTD., Japan) comprising PET and a protective layer of cyclic olefin copolymer (COC). In use, the protective layer of COC is in contact with the electrolyte membrane 20.

A first electrode first composition can be applied to the first side 22 of the electrolyte membrane 20 via the first electrode first composition deposition apparatus 40. The first electrode first composition comprises a first catalyst, an ion exchange material and a liquid carrier. The first catalyst comprises a first catalytic component and a first catalyst support. The electrolyte membrane may be on a releasable backing layer as discussed above positioned on roll feed and/or roll winder (not shown). The releasable backing layer is in contact with the roll feed and/or roll winder such that the releasable backing layer lies between the electrolyte membrane 20 and the roll feed and/or roll winder. The application of the first electrode first composition forms a wet layer of the first electrode first composition 34 on the first side 22 of the electrolyte membrane 20.

The term “applying” is intended to include but not be limited to various means of applying liquid compositions, such as slot die coating, slide die coating, curtain coating, gravure coating, reverse roll coating, spray coating, knife-over-roll coating, and dip coating. The first electrode composition deposition apparatus 40 may therefore be a slot die coating apparatus, a slide die coating apparatus, a curtain coating apparatus, a gravure coating apparatus, a reverse roll coating apparatus, a spray coating apparatus, a knife-over-roll coating apparatus, or a dip coating apparatus. A slot die coating apparatus is preferred.

The layer of the first electrode first composition 34 may have a first side 33 and an opposing second side 35, with the first side 33 in contact with the first side 22 of the electrolyte membrane 20.

A first intermediate assembly is provided comprising in order, an optional releasable backing layer, electrolyte membrane 20 and wet layer of first electrode first composition 34. The first intermediate assembly may then be heated to remove liquid carrier from the layer of first electrode first composition 34. For instance, the first intermediate assembly may be conveyed to any suitable first heating device 65, such as an oven, drier or IR lamp, via the roll feed and/or roll winder. The heating may be carried out at a temperature greater than 60° C., greater than 75° C., greater than 100° C., greater than 130° C., from 60° C. to 160° C., or from 100° C. to 150° C., optionally at a drying time from 0.01 to 10 minutes, e.g., from 0.1 to 8 minutes, from 0.1 to 5 minutes, from 0.1 to 2 minutes, or from 0.1 to 1 minute. During drying, the liquid carrier evaporates from the uncovered second side 35 of the layer of the first electrode first composition 34. The drying of the wet layer of first electrode first composition 34 forms a dry first electrode first layer 30a on the electrolyte membrane 20 comprising the first catalyst and ion exchange material. The dry first electrode first layer 30a has a first side 31a in contact with the first side 22 of the electrolyte membrane 20 and an opposing second side 36.

When the layer of the first electrode first composition 34 has been dried to form the first electrode first layer 30a, a first electrode second composition is applied to the second side 36 of the first electrode first layer 30a via the first electrode second composition deposition apparatus 50. The first electrode second composition comprises a first catalyst, an ion exchange material and a liquid carrier. The first catalyst comprises a first catalytic component and a first catalyst support. The weight ratio of ion exchange material to first catalyst support in the first electrode second composition is less than the weight ratio of ion exchange material to first catalyst support in the first electrode first composition. This is discussed in more detail below.

The first electrode second composition deposition apparatus 50 may be independently selected from those means discussed for the first electrode first composition deposition apparatus 40. A wet layer of the first electrode second composition 38 on the second side 36 of the first electrode first layer 30a is therefore provided. The layer of the second electrode second composition 38 has a first side 37 and an opposing second side 39. The first side 37 is in contact with the second side 36 of the first electrode first layer 30a The second side 39 of the layer of the first electrode second composition is exposed to the local environment.

A second intermediate assembly is provided, comprising in order, an optional releasable backing layer, electrolyte membrane 20, dry first electrode first layer 30a and wet layer of first electrode second composition 38. The second intermediate assembly may then be heated to remove liquid carrier from the layer of first electrode second composition 38. For instance, the second intermediate assembly may be conveyed to any suitable second heating device 70, such as an oven, drier or IR lamp, via the roll feed and/or roll winder (not shown). The heating may be carried out at a temperature greater than 60° C., greater than 75° C., greater than 100° C., greater than 130° C., from 60° C. to 160° C., or from 100° C. to 150° C., optionally at a drying time from 0.01 to 10 minutes, e.g., from 0.1 to 8 minutes, from 0.1 to 5 minutes, from 0.1 to 2 minutes, or from 0.1 to 1 minute. The drying of the wet layer of the first electrode second composition 38 forms a dry first electrode second layer 30b comprising first catalyst and ion exchange material. The combination of the dry first electrode first layer 30a and dry first electrode second layer 30b provides first electrode 30 comprising first catalyst and ion exchange material on the electrolyte membrane 20. During drying, the liquid carrier evaporates from the uncovered second side 39 of the layer of the first electrode second composition 38.

If only a single layer of first electrode composition had been deposited, this evaporation would have set up a diffusion gradient across the wet layer of the first electrode composition, producing a net movement of liquid carrier to the surface of composition. Ion exchange material is mobile in the liquid carrier and can move with the liquid carrier as it migrates to the surface of a first electrode composition to evaporate. The concentration of the ion exchange material can therefore increase in the layer of the first electrode composition near its upper surface during heating to remove the liquid carrier.

This migration of ion exchange material can lead to a relatively lower concentration of ion exchange material in the portion of a dried first electrode nearest to the electrolyte membrane, causing diminished ion transport to the catalyst particles in the electrode once dried. Furthermore, a relatively higher concentration of ion exchange material in the portion of the first electrode nearest to the electrode surface and any gas diffusion layer (and opposite to the side of the first electrode in contact with the electrolyte membrane), can reduce the porosity at the surface of the first electrode by the filling of pores with the ion exchange material, reducing the volume of the triple phase boundary present.

However, in the processes described herein, by providing a dried first electrode first layer 30a formed from a first electrode first composition in which the weight ratio of ion exchange material to first catalyst support is greater than the weight ratio of ion exchange material to first catalyst support in the first electrode second composition, migration of ion exchange material from the region nearest the electrolyte membrane is mitigated. Furthermore, by heating the layer of first electrode first composition 34 to provide the first electrode first layer 30a prior to applying the layer of the first electrode second composition 38, migration of ion exchange material from the layer of first electrode first composition 34 to the layer of first electrode second composition 38 upon drying is prevented because the ion exchange material in the first electrode first layer 30a is not mobile due to removal of the liquid carrier. Thus, the final concentration of ion exchange material in the portion of the first electrode at its second side surface is lower than if the first electrode was deposited from a single first electrode composition having the average concentration of ion exchange material of the first electrode first and second compositions.

In this way, the second heating step provides a membrane electrode assembly, comprising in order, an optional releasable backing layer, an electrolyte membrane 20 and a first electrode 30 comprising first electrode first layer 30a and first electrode second layer 30b.

In an alternative embodiment not shown in FIG. 1, the two wet layers of first electrode first composition 34 and first electrode second composition 38 may be substantially dried simultaneously. In this way both layers of the first electrode first composition and first electrode second composition were wet when heated, the dried first electrode 30 comprising first catalyst and ion exchange material can be formed as a continuous phase i.e. the first electrode 30 may be free from internal interfaces.

In an optional step not shown in FIG. 1, a first releasable support layer may be applied to the first electrode 30 after the second heating step. The first electrode may comprise a first side and an opposing second side. The first side of the first electrode layer is in contact with the first side of the electrolyte membrane in the MEA component. A first releasable support layer may be applied to the second side of the first electrode before the application of any second electrode, such as a second electrode first composition to the second side of the electrolyte membrane as discussed for the process of FIG. 2.

The first releasable support layer protects the second side of the first electrode and provides support and stability to the MEA component for subsequent processing steps. The first releasable support layer may comprise a single layer or film, which can be formed of a plastics material. The first releasable support layer can be a film or fabric, such as a woven material or a non-woven material, such as a web. Suitable first releasable support layers may comprise woven materials which may include, for example, scrims made of woven fibers of expanded porous polytetrafluoroethylene; webs made of extruded or oriented polypropylene or polypropylene netting, commercially available from Conwed, Inc. of Minneapolis, Minn.; and woven materials of polypropylene and polyester, from Tetko Inc., of Briarcliff Manor, N.Y. Suitable non-woven materials for the first releasable support layer may include, for example, a spun-bonded polypropylene from Reemay Inc. of Old Hickory, Tenn. Other suitable first releasable support layers may comprise a web of polyethylene (“PE”), polystyrene (“PS”), cyclic olefin copolymer (“COC”), cyclic olefin polymer (“COP”), fluorinated ethylene propylene (“FEP”), perfluoroalkoxy alkanes (“PFAs”), ethylene tetrafluoroethylene (“ETFE”), polyvinylidene fluoride (“PVDF”), polyethermide (“PEI”), polysulfone (“PSU”), polyethersulfone (“PES”), polyphenylene oxide (“PPO”), polyphenyl ether (“PPE”), polymethylpentene (“PMP”), polyethyleneterephthalate (“PET”), or polycarbonate (“PC”). The first releasable support layer preferably comprises a polyethersulfone (“PES”) film or a polyethyleneterephthalate (“PET”) film.

The first releasable support layer may have a thickness of lower than 250 microns, lower than 200 microns, lower than 150 microns, lower than 100 microns, lower than 50 microns.

The first releasable support layer can be applied to the second side of the first electrode by a hot roll lamination process. The lamination process may comprise a heated roll pressing step. The heated roll may have a temperature of about 160° C. The lamination pressure may be between 0.35 MPa/m and 0.50 MPa/m, preferably at about 0.48 MPa/m or at about 0.42 MPa/m.

In this way, the step of applying the first releasable support layer provides a membrane electrode assembly component, comprising in order, an optional releasable backing layer, an electrolyte membrane, a first electrode and a first releasable support layer.

The processes described herein may further provide a second electrode on the opposite side of the electrolyte membrane to the first electrode.

FIG. 2 shows a schematic process 100 for the manufacture of a MEA, including application of a layer of a second electrode first composition 134 and a layer of a second electrode second composition 138 to a second side 24 of an electrolyte membrane 20 and heating to dry the second electrode first and second compositions 134, 138. The second electrode first composition and first electrode second composition are liquid compositions.

The first side 22 of the electrolyte membrane 20 is in contact with a first electrode 30 produced as previously described. If the electrolyte membrane 20 is provided with a releasable backing layer in contact with the second side 24 of the electrolyte membrane 20, the releasable backing layer can be separated to uncover the second side 24 of the electrolyte membrane 20.

The electrolyte membrane 20 can be positioned with the first electrode 30 in contact with a roll feed and/or roll winder (not shown) with the second side 24 of the electrolyte membrane 20 uppermost and uncovered. If an optional first releasable support layer (not shown) is present on the second side of the first electrode 30, the first releasable support layer would be located in contact with the roll feed and/or roll winder, between the first electrode 30 and roll feed and/or roll winder.

In a continuous process, the membrane electrode assembly comprising the first electrode 30 on the electrolyte membrane 20 may be flipped or inverted such that the second side 24 of the electrolyte membrane 20 forms the uppermost surface and is conveyed to a second electrode first composition deposition apparatus 140, for instance via the roll feed and/or roll winder.

A second electrode first composition 134 can be applied to the second side 24 of the electrolyte membrane 20 via the second electrode first composition deposition apparatus 140. The second electrode first composition 134 comprises a second catalyst, an ion exchange material and a liquid carrier. The second catalyst comprises a second catalytic component and a second catalyst support. The applying of the second electrode first composition forms a wet layer of the second electrode first composition 134 on the second side 24 of, and in contact with, the electrolyte membrane 20. The applying can be carried out by one of the means disclosed for applying the first electrode first composition, such that the second electrode first composition deposition apparatus 140 may be independently selected from those discussed for the first electrode first deposition apparatus 40.

The layer of the second electrode first composition 134 may have a first side 133 and an opposing second side 135, with the first side 133 in contact with the second side 24 of the electrolyte membrane 20.

Whilst the layer of second electrode first composition 134 is still wet, a second electrode second composition 138 is applied to the second side 135 of the layer of the second electrode first composition 134 via the second electrode second composition deposition apparatus 150. The applying can be carried out by one the means as the first electrode first and second compositions, such that the second electrode second composition deposition apparatus 150 may be independently selected from those discussed for the first electrode first composition deposition apparatus 40.

The second electrode second composition comprises a second catalyst, an ion exchange material and a liquid carrier. The second catalyst comprises a second catalytic component and a second catalyst support. The weight ratio of ion exchange material to second catalyst support in the second electrode second composition is less than the weight ratio of ion exchange material to second catalyst support in the second electrode first composition. This is discussed in more detail under the electrode composition below.

A wet layer of the second electrode second composition 138 on the second side 135 of the layer of the second electrode first composition 134 is therefore provided. The layer of the second electrode second composition has a first side 137 and an opposing second side 139. The first side 137 is in contact with the second side 135 of the layer of the second electrode first composition 134. The second side 139 of the layer of the second electrode second composition 138 is exposed to the local environment.

A multi-layer assembly, comprising in order, an optional first releasable support layer (not shown), first electrode 30, electrolyte membrane 20, layer of second electrode first composition 134 and layer of second electrode second composition 138 may then be heated to remove liquid carrier from the layer of second electrode first composition 134 and the layer of second electrode second composition 138. In one embodiment, the two wet layers 134 and 138 may be substantially dried simultaneously to form a second electrode comprising second catalyst and ion exchange material. In this way the layers of the second electrode first composition and first electrode second composition were wet when heated, the dried second electrode 130 can be formed as a continuous phase i.e. the second electrode 130 may be free from internal interfaces.

For instance, the second multi-layered assembly may be conveyed to any suitable second electrode heating device 165, such as an oven, drier or IR lamp, via the roll feed and/or roll winder. The heating may be carried out at temperatures and durations independently selected from those described above for the two wet layers 34 and 38 of the first electrode 30. The drying of the two wet layers of second electrode first composition 134 and second electrode second composition 138 forms a dry second electrode 130 comprising second catalyst and ion exchange material on the electrolyte membrane 20.

Heating evaporates the liquid carrier from the uncovered second side 139 of the layer of the second electrode second composition 138. This evaporation sets up a diffusion gradient across the wet layers of the second electrode first and second compositions, producing a net movement of liquid carrier to the surface of second side 139. Ion exchange material is mobile in the liquid carrier and can move with the liquid carrier as it migrates to the surface of the second side 139 of the second electrode second composition 138 to evaporate. The concentration of the ion exchange material can therefore increase in the layer of the second electrode second composition 138 during heating to remove the liquid carrier.

The weight ratio of ion exchange material to second catalyst support in the second electrode first composition is greater than the weight ratio of ion exchange material to second catalyst support in the second electrode second composition. Thus, when migration of the ion exchange material occurs within the two layers 134, 138 forming the second electrode 130 during heating and drying, the final concentration of ion exchange material in the portion of the second electrode at its second side surface is lower than if the first electrode was deposited from a single second electrode composition having the average concentration of ion exchange material of the second electrode first and second compositions.

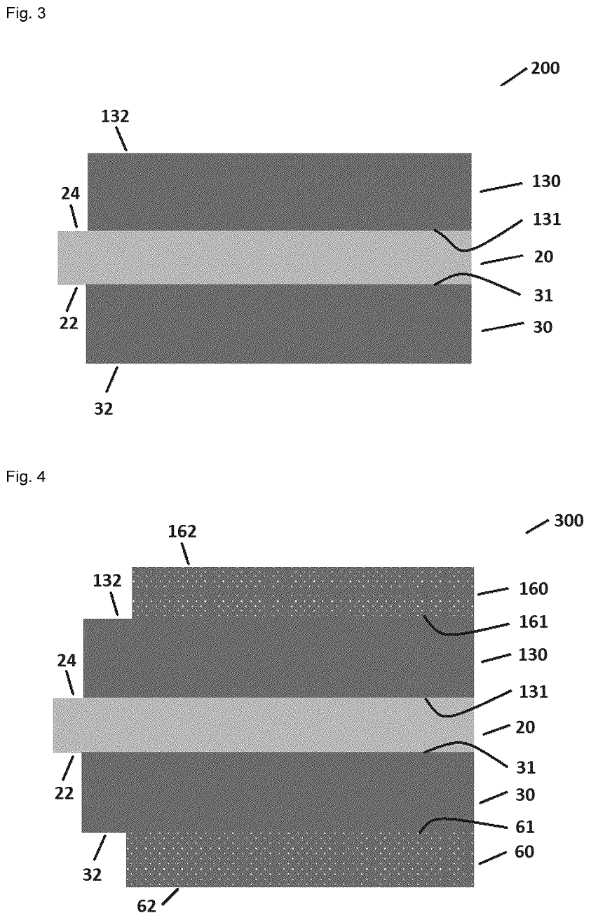

In this way, the heating step provides a membrane electrode assembly as shown in FIG. 3, comprising in order, a first electrode 30, an electrolyte membrane 20 and a second electrode 130.

In an alternative embodiment not shown in FIG. 2, the layer of the second electrode first composition 134 may be dried before the layer of the second electrode second composition 138 is applied. Heating the layer of the second electrode first composition 134 in a first second electrode heating device to remove liquid carrier would provide a dry second electrode first layer comprising second catalyst and ion exchange material. A first side of the second electrode first layer would be in contact with the second side of the electrolyte membrane. After heating, a layer of second electrode second composition can be applied to a second side of the second electrode first layer opposite to that of the first side. Heating the layer of second electrode first composition to provide the second electrode first layer prior to applying the layer of the second electrode second composition, prevents migration of ion exchange material from the layer of second electrode first composition to the layer of second electrode second composition upon drying because the ion exchange material in the second electrode first layer is not mobile due to lack of liquid carrier. Heating the layer of the second electrode second composition in a second electrode heating device to remove liquid carrier would provide a second electrode second layer comprising second catalyst and ion exchange material on the second side of the second electrode first layer. A second electrode comprising second catalyst and ion exchange material is therefore formed comprising the second electrode first layer and second electrode second layer, in a similar manner to the process of FIG. 1.

The processes described herein may be provided as a continuous process for producing an MEA component in which the electrolyte membrane and any releasable backing layer can be positioned on roll feed and/or roll winder and conveyed to first electrode first and second composition deposition apparatus and corresponding first and second heating apparatus. Similarly, the first electrode and electrolyte membrane can be conveyed on a roll feed and/or roll winder and conveyed to second electrode first and second composition deposition apparatus and then second electrode heating apparatus.

In a further step not shown in the embodiments of FIG. 1 or FIG. 2, a first gas diffusion layer (GDL) may be provided on the membrane electrode assembly component or membrane electrode assembly. The first GDL 60 may have a first side 61 and an opposing second side 62. The first side 61 of the first GDL 60 may be applied to the second side 32 of the first electrode 30 to provide a membrane electrode assembly comprising, in order, the first gas diffusion layer 60, the first electrode 30, the electrolyte membrane 20 and any second electrode 130. The first gas diffusion layer may be applied to the second side of the first electrode by any conventional technique, such as lamination. For instance, the first GDL can be laminated to the first electrode under pressure and with heating. The first gas diffusion layer may comprise a porous carbon particle layer, such as microporous carbon paper.

If the membrane electrode assembly component or membrane electrode assembly is provided with a first releasable support layer on the second surface of the first electrode, the process further comprises the step of separating the first releasable support layer from the first electrode before the first gas diffusion layer is applied to the second side of the first electrode.

In a further step not shown in the embodiments of FIG. 2, a second gas diffusion layer may be provided. The second GDL 160 may have a first side 161 and an opposing second side 162. The first side 161 of the second GDL 160 may be applied to the second side 132 of the second electrode 130 to provide a membrane electrode assembly 300 comprising, in order, the first gas diffusion layer 60, the first electrode 30, the electrolyte membrane 20, the second electrode 130 and the second gas diffusion layer 160 as shown in FIG. 4. The second gas diffusion layer may comprise a porous carbon particle layer, such as microporous carbon paper.

If the membrane electrode assembly is provided with a second releasable support layer on the second surface of the second electrode, the process further comprises the step of separating the second releasable support layer from the second electrode before the second gas diffusion layer is applied to the second side of the second electrode.

### First Electrode First Compositions and Second Electrode Second Compositions

Each of the electrode compositions, namely the first electrode first composition, first electrode second composition and any second electrode first composition and second electrode second composition comprises a catalyst, an ion exchange material and a liquid carrier.

It is essential that for a given electrode, such as the first electrode or any second electrode, the weight ratio of ion exchange material to catalyst support in the electrode first composition is greater than the weight ratio of ion exchange material to catalyst support in the electrode second composition used to deposit the particular electrode.

The difference between the weight ratio of the ion exchange material to the first catalyst support in the first electrode first composition and the weight ratio of the ion exchange material to the first catalyst support in the first electrode second composition may be at least 0.4, or at least 0.5, or at least 0.6, or at least 0.7, or at least 0.8, or at least 0.9.

The difference between the weight ratio of the ion exchange material to the first catalyst support in the first electrode first composition and the weight ratio of the ion exchange material to the first catalyst support in the first electrode second composition may be less than 2, or less than 1.9, or less than 1.8, or less than 1.7, or less than 1.6, or less than 1.5.

The difference between the weight ratio of the ion exchange material to the first catalyst support in the first electrode first composition and the weight ratio of the ion exchange material to the first catalyst support in the first electrode second composition, may be in the range of from 0.4 to less than 2, or in the range of from 0.5 to less than 1.9, or in the range of from 0.6 to less than 1.8, or in the range of from 0.7 to less than 1.8, or in the range of from 0.8 to less than 1.7, or in the range of from 0.9 to less than 1.6, or in the range of from 1 to less than 1.5. In some embodiments, the difference between the weight ratio of the ion exchange material to the first catalyst support in the first electrode first composition and the weight ratio of the ion exchange material to the first catalyst support in the first electrode second composition may be about 1.3.

The weight ratio of the ion exchange material to the first catalyst support, in the first electrode first composition may be in the range of from 1.4 to 2.4. The weight ratio of the ion exchange material to the first catalyst support in the first electrode second composition may be in the range of from 0.4 to less than 1.4. Preferably, the weight ratio of the ion exchange material to the first catalyst support in the first electrode first composition is in the range of from 1.6 to 2.1 and the weight ratio of the ion exchange material to the first catalyst support in the first electrode second composition is in the range of from 0.5 to 1.2.

The average of the weight ratio of the ion exchange material to the first catalyst support in the layer of first electrode first composition and the weight ratio of the ion exchange material to the first catalyst support in the layer of first electrode second composition is from 1.0 to 1.6, preferably from 1.1 to 1.5

The difference between the weight ratio of the ion exchange material to the second catalyst support in the second electrode first composition and the weight ratio of the ion exchange material to the second catalyst support in the second electrode second composition may be at least 0.4, or at least 0.5, or at least 0.6, or at least 0.7, or at least 0.8. Preferably this difference is at least 0.9.

The difference between the weight ratio of the ion exchange material to the second catalyst support in the second electrode first composition and the weight ratio of the ion exchange material to the second catalyst support in the second electrode second composition may be less than 2, or less than 1.9, or less than 1.8, or less than 1.7, or less than 1.6. Preferably this difference is less than 1.5.

The difference between the weight ratio of the ion exchange material to the second catalyst support in the second electrode first composition and the weight ratio of the ion exchange material to the second catalyst support in the second electrode second composition, may be in the range of from 0.4 to less than 2, or in the range of from 0.5 to less than 1.9, or in the range of from 0.6 to less than 1.8, or in the range of from 0.7 to less than 1.8, or in the range of from 0.8 to less than 1.7. This difference may be preferably in the range of from 0.9 to less than 1.5.

The weight ratio of the ion exchange material to the second catalyst support in the second electrode first composition may be in the range of from 1.4 to 2.4. The weight ratio of the ion exchange material to the second catalyst support in the second electrode second composition may be in the range of from 0.4 to less than 1.4. Preferably, the weight ratio of the ion exchange material to the second catalyst support in the second electrode first composition is in the range of from 1.6 to 2.1 and the weight ratio of the ion exchange material to the second catalyst support in the second electrode second composition is in the range of from 0.5 to 1.2.

The average of the weight ratio of the ion exchange material to the second catalyst support in the layer of second electrode first composition and the weight ratio of the ion exchange material to the second catalyst support in the layer of second electrode second composition is from 1.0 to 1.6, preferably from 1.1 to 1.5.

The first electrode composition comprises a first catalyst and any second electrode composition comprises a second catalyst. The first and second catalysts may be the same or different.

There is no particular restriction on a catalyst employed for the first and any second catalysts, and any known catalyst can be used, such as those typically used for an anode or a cathode of a fuel cell. The nature of the catalyst may vary widely. The catalyst comprises a catalytic component, such as noble metals, transition metals, or alloys thereof. The catalytic component may be one or more catalytic components. The one or more catalytic components may be selected from the group comprising Pt, Ir, Ni, Co, Pd, Ti, Sn, Ta, Nb, Sb, Pb, Mn, Ru and Fe, their oxides, and mixtures thereof. More specific examples of catalytic components include platinum, ruthenium, iridium, cobalt, and palladium, and are not limited to elemental metals. For example, the catalyst may also comprise iridium oxide, a platinum-ruthenium alloy, a platinum-iridium alloy, a platinum-cobalt alloy, etc. In some embodiments, the catalyst comprises a core shell catalyst, as described, for example, in US2016/0126560, the entirety of which is incorporated herein by reference. In some embodiments, the catalyst may comprise a catalyst support, such that it is a supported catalyst. Such supported catalysts may comprise carbon as the support material, preferably carbon black. For example, in some embodiments, the catalyst comprises a supported platinum catalyst, such as platinum on carbon black.

The catalyst loading in terms of the catalytic component, for instance platinum, such as that of the first catalyst or any second catalyst, in the electrode first composition of an electrode, such as the first or any second electrode, may be in the range of from 0.05 to 0.25 mg/cm² for the electrode first composition after the removal of the liquid carrier. The catalyst loading in terms of the catalytic component, for instance platinum, such as that of the first catalyst or any second catalyst, in the electrode second composition of an electrode, such as the first or any second electrode, may be in the range of from 0.15 to 0.45 mg/cm² for the electrode second composition after the removal of the liquid carrier.

In some embodiments, the catalyst loading in the electrode first composition and electrode second composition of an electrode, such as the first or any second electrode, may be substantially the same after removal of the liquid carrier.

The catalyst, in terms of its total weight of the catalyst i.e. the catalytic component and catalyst support, may be present in the electrode composition in an amount less than about 90 wt. %, less than about 50 wt. %, or less than about 20 wt. %, based on a total weight of the electrode first or second composition. For example, the catalyst may be present in the first or any second electrode first or second composition in an amount from 1 wt. % to 90 wt. %, from 1 wt. % to 50 wt. %, or from 3 wt. % to 20 wt. %, based on a total weight of the electrode first or second composition.

A suitable ion exchange material may be dependent on the application in which the membrane electrode assembly is to be used. The ion exchange material may be chemically and thermally stable in the environment in which the membrane electrode assembly is to be used. A suitable ion exchange material for fuel cell applications may include a cation exchange material, an anion exchange material, or an ion exchange material containing both cation and anion exchange capabilities. Mixtures of ion exchange materials may also be employed.

In some embodiments, the ion exchange material comprises a proton conducting polymer or cation exchange material. The ion exchange material may be selected from the group comprising perfluorocarboxylic acid polymers, perfluorophosphonic acid polymers, styrenic ion exchange polymers, fluorostyrenic ion exchange polymers, polyarylether ketone ion exchange polymers, polysulfone ion exchange polymers, bis(fluoroalkylsulfonyl)imides, (fluoroalkylsulfonyl) (fluorosulfonyl)imides, polyvinyl alcohol, polyethylene oxides, divinyl benzene, metal salts with or without a polymer and mixtures thereof. Examples of suitable perfluorosulfonic acid polymers for use in fuel cell applications include Nafion® (E.I. DuPont de Nemours, Inc., Wilmington, Del., US), Flemion® (Asahi Glass Co. Ltd., Tokyo, JP), Aciplex® (Asahi Chemical Co. Ltd., Tokyo, JP), Aquivion® (SolvaySolexis S.P.A, Italy), and 3M™ (3M Innovative Properties Company, USA) which are commercially available perfluorosulfonic acid copolymers. Other examples of suitable perfluorosulfonic acid polymers for use in fuel cell applications include perfluorinated sulfonyl (co)polymers such as those described in U.S. Pat. No. 5,463,005.

The ion exchange material may be present in the electrode first or second composition of a first or any second electrode in an amount less than about 50 wt. %, less than about 35 wt. %, or less than about 8 wt. %, based on a total weight of the ion exchange material and liquid carrier in the electrode composition. For example, the ion exchange material may be present in the first or any second electrode first or second composition in an amount from 0.5 wt. % to 50 wt. %, based on a total weight of the ion exchange material and liquid carrier in the electrode composition, preferably in the range of from 0.5 wt. % to 8 wt. %, based on a total weight of the ion exchange material and liquid carrier in the electrode composition.

The liquid carrier may comprise one or more compounds selected from water, a water-soluble alcohol or a glycol ether. The water-soluble alcohol may be a C₂-C₄ alcohol, such as one or more of ethanol, 1-propanol, 2-propanol and 2-methyl-2-propanol. The glycol ether may be dipropylene glycol (DPG) or propylene glycol methyl ether (PGME). The liquid carrier may comprise water and ethanol. The ratio of water to ethanol may be in the range of from 1:2 to 2:1 by volume. Preferably the ratio of water to ethanol in the liquid carrier is about 1:1 by volume, on a mixing basis i.e. by volume prior to mixing. Alternatively, the liquid carrier may comprise water and 1-propanol. The ratio of water to 1-propanol may be in the range of from 1:2 to 2:1 by weight. Preferably the concentration of water in the liquid carrier is in the range of from 40 to 60% by weight of the liquid carrier and the concentration of 1-propanol is in the range of from 60 to 40% by weight of the liquid carrier.

When the liquid carrier comprises water, the first or second electrode compositions of a first or any second electrode, may be aqueous first or second electrode first or second compositions.

The electrode first or second compositions may comprise greater than about 35 wt. %, greater than about 50 wt. %, greater than about 70 wt. %, greater than about 80 wt. %, or greater than about 90 wt. % liquid carrier, based on a total weight of the ion exchange material and liquid carrier in the aqueous mixture. For example, the liquid carrier may be present in the first or any second electrode first or second composition in an amount from about 35 wt. % to about 99 wt. %, based on a total weight of the ion exchange material and liquid carrier.

It will be appreciated that the specific concentrations of the components in the electrode compositions that are required to achieve the benefits herein described may vary widely within the ranges listed, depending, for example, on the electrolyte membrane on which the electrode composition is to be applied, since the wettability of the electrolyte membrane will vary depending, for example, on porosity, pore size, and surface energy of the electrolyte. The desired catalyst loading in the electrode composition and on the electrolyte membrane will also impact the desired component concentrations. As a result, the above concentrations are provided as guidelines, understanding that some degree of optimization, well within the purview of those of ordinary skill in the art, may be necessary depending on the chosen electrolyte membrane and desired catalyst loading.

The first or any second electrode first or any second composition may further comprise a water-insoluble component comprising one or both of a water-insoluble alcohol and a water-insoluble carboxylic acid. In some embodiments, the water-insoluble component comprises a C₅₊ alcohol, a C₅₊ carboxylic acid, or a combination thereof. As used herein, C₅₊ refers to compounds having five or more carbon atoms. Preferably, the water-insoluble component comprises a C₅-C₁₀ alcohol, a C₅-C₁₀ carboxylic acid, or a combination thereof. Thus, in some embodiments, the water-insoluble component comprises a water-insoluble alcohol, such as, for example, 1-pentanol, 1-hexanol, 1-heptanol, 1-octanol, 2-ethyl-1-hexanol, 1-nonanol, 1-decanol, or a combination thereof. In some embodiments, the water-insoluble component comprises a water-insoluble carboxylic acid, such as, for example, n-pentanoic acid, n-hexanoic acid, n-heptanoic acid, n-octanoic acid, n-nonanoic acid, n-decanoic acid or a combination thereof. As used here, the term “a combination thereof” refers to any combination of two or more species in the immediately preceding list. Branched alcohols and/or branched carboxylic acids are also contemplated, as are various combinations of C₅₊ alcohols and C₅₊ carboxylic acids.

The water-insoluble component may be present in the first or any second electrode first or second composition in an amount less than about 20 wt. %, less than about 15 wt. %, less than about 10 wt. %, less than about 8 wt. %, less than about 6 wt. %, or less than about 4 wt. %, based on a total weight of the ion exchange material and liquid carrier in the electrode composition. For example, the water-insoluble component may be present in the first or any second electrode first or second composition in an amount from 0.5 wt. % to 20 wt. %, e.g., from 0.5 wt. % to 15 wt. %, from 0.5 wt. % to 10 wt. %, from 1 wt. % to 20 wt. %, from 5 wt. % to 20 wt. %, or from 10 wt. % to 20 wt. %, based on a total weight of the ion exchange material and liquid carrier in the electrode composition. The weight percentages recited herein should be considered as applying to the collective amount of all water-insoluble components for embodiments employing more than one water-insoluble component.

Such electrode compositions comprising the above water-insoluble component produce low contact angles when the compositions are applied to an electrolyte membrane, such that the electrode compositions satisfactorily wet the electrolyte membrane even with little or no use of water-soluble alcohols and show low reticulation during the drying process. “Low reticulation” as used herein is intended to mean any film that contracts less than 15% in width, less than 15% in length, and for which the final area of the film comprised less than 15% de-wetting defects. Reticulation was assessed by pipetting 60-80 microliters of the aqueous mixture onto the substrate, then using a pipet bulb to spread the aqueous mixture on the electrolyte membrane to form a film with a length of 4-6 cm and a width of 7-15 mm, then drying the film in less than 1 minute with a heat gun while visually inspecting.

Without being limited by theory, it is speculated that the ion exchange material, which is not considered a surfactant, surprisingly emulsifies the water-insoluble component. The electrode compositions have adequate stability to permit coating by the manufacturing processes described herein The electrode compositions according to various embodiments may include an emulsion or a suspension such that the electrode compositions may maintain a single phase during the depositing process (i.e., the electrode compositions do not separate into an “oil-rich layer” and “water-rich layer” too rapidly to prevent application to the electrolyte membrane and heating to remove the liquid carrier). According to various embodiments, the electrode compositions remain homogenous where the components (e.g. oil, water, etc.) are uniformly distributed during at least the step of application.

### Membrane Electrode Assembly

FIG. 3 shows a schematic diagram of a membrane electrode assembly 200 produced according to an embodiment of the described process. The MEA 200 comprises in order, a first electrode 30, an electrolyte membrane 20 and a second electrode 130. The first electrode 30 has a first side 31 and an opposing second side 32. The electrolyte membrane 20 has a first side 22 and an opposing second side 24. The second electrode 130 has a first side 131 and an opposing second side 132. The first side 31 of the first electrode 30 is in contact with the first side 22 of the electrolyte membrane 20. The first side 131 of the second electrode 130 is in contact with the second side 24 of the electrolyte membrane 20.

The catalyst loading of an electrode, such as the first or any second electrode, may be in the range of from about 0.05 to about 0.5 mg/cm², or from about 0.06 to about 0.45 mg/cm², or from about 0.07 to about 0.4 mg/cm², or from about 0.08 to about 0.37 mg/cm², or from about 0.09 to about 0.33 mg/cm², or from about 0.1 to about 0.3 mg/cm².

Optionally, the second side of the first electrode may be protected by a first releasable support layer (not shown). Such a supported MEA comprises in order, a first releasable support layer, a first electrode, an electrolyte membrane and a second electrode.

Further optionally, the second side of the second electrode may be protected by a second releasable support layer (not shown). Such a supported MEA comprises in order, a first releasable support layer, a first electrode, an electrolyte membrane, a second electrode and a second releasable support layer. The second releasable support layer may be independently provided from the same materials as the first releasable support layer disclosed above.

FIG. 4 shows a schematic diagram of a membrane electrode assembly 300 produced according to an embodiment of the described process. The MEA 300 comprises in order, a first gas diffusion layer 60, a first electrode 30, an electrolyte membrane 20, a second electrode 130 and a second gas diffusion layer 160. The first GDL 60 has a first side 61 and an opposing second side 62. The second GDL 160 has a first side 161 and an opposing second side 162. The first side 61 of the first GDL 60 is in contact with the second side 32 of the first electrode 30. The first side 161 of the second GDL 160 is in contact with the second side 132 of the second GDL 160. The remaining reference numerals are the same as those for FIG. 3.

The membrane electrode assembly of FIG. 4 may be a fuel cell membrane electrode assembly.

### Fuel Cell

A fuel cell may be provided with an MEA as described herein, such as an MEA as described in the embodiment of FIG. 4.

When the membrane electrode assemblies are membrane electrode assemblies in a fuel cell, the first and second electrodes may have a pore size of less than or equal to about 100 nm. The first and second catalysts may comprise a platinum catalyst supported on carbon black.

### Examples

The present disclosure will be better understood in view of the following non-limiting examples.

The electrode compositions of Comparative Example 1 and Example 1 were prepared by combining a platinum catalyst supported on carbon (TEC10F50E-HT from Tanaka Kikinzoku Kogyo K K., Japan) and a perfluorosulfonic acid ion exchange material (Asahi Glass Co., Ltd, Japan) and liquid carrier comprising 1:1 by volume of 1-propanol and distilled water to provide an electrode composition having 5 vol % solids. The proportions of ion exchange material to catalyst support by weight and catalyst loading (in terms of Pt catalytic component by weight) for the electrode compositions are shown in Table 1 below. The electrode compositions were mixed by supersonic homogenizer (UP200S, by Hielscher Ultrasonics GmbH, Germany) at 60° C. for 2 minutes to disperse the catalyst. The ratio of ion exchange material to catalyst was determined by thermogravimetric analysis after drying the compositions at 140° C. for 12 hours in an air oven and then grinding in an electric grinder to reduce the particle size to less than 1 mm.

### Comparative Example 1 (“Direct 1-Pass”)

A polymer electrolyte membrane comprising a perfluorosulfonic acid ionomer reinforced with an ePTFE microporous support and a PEM thickness of about 15 to 18 microns (commercially available by W. L. Gore & Associates, Inc.) was provided. A slot die was used to apply (coating width 54 mm) a single layer of the electrode first composition to the surface of the PEM. The slot dye was in liquid connection with a pump commercially available as a syringe pump 200 series (KDS Legato, Sigma-Aldrich) to supply the electrode first composition at a flowrate of 4.46 ml/min. The layer of electrode first composition was then dried at 60° C. for two minutes to provide a cathode electrode in contact with the surface of the PEM.

### Example 1 (“Direct Multilayer”)

A polymer electrolyte membrane comprising a perfluorosulfonic acid ionomer reinforced with an ePTFE microporous support and a PEM thickness of about 15 to 18 microns (commercially available from W. L. Gore & Associates, Inc.) was provided. A slot die was used to apply (coating width 54 mm) a layer of the electrode first composition to the surface of the PEM. The slot dye was in liquid connection with a pump commercially available as a syringe pump 200 series (KDS Legato, Sigma-Aldrich) to supply the electrode first composition at a flowrate of 4.46 ml/min. The layer of electrode first composition was then dried at 60° C. for two minutes to provide an electrode first layer in contact with the surface of the PEM.

A slot die was used to apply (coating width 54 mm) a layer of the electrode second composition to the surface of the dried electrode first layer. The slot dye was in liquid connection with a pump commercially available as a syringe pump 200 series (KDS Legato from Sigma-Aldrich) to supply the electrode second composition at a flowrate of 4.46 ml/min. The layer of the electrode second composition was then dried at 60° C. for two minutes to provide an electrode second layer in contact with the electrode first layer to provide a cathode comprising the electrode first and second layers on the PEM.

TABLE 1

| | Electrode 1^{st} | | Electrode 2^{nd} | |
|---|---|---|---|---|
| | composition | | composition | |
| | | Pt loading | | Pt loading |
| | I/C* | (mg/sq · cm) | I/C* | (mg/sq · cm) |
| Comparative | 1.2 | 0.2 | 1.2 | 0.2 |
| Example 1 | | | | |
| Example 1 | 1.75 | 0.2 | 0.65 | 0.2 |

*I/C is the weight ratio of IEM to carbon catalyst support

An anode was then applied to the side of the PEM opposite to that of the cathode by hot pressing in the MEA components of Comparative Example 1 and Example 1. A gas diffusion layer comprising carbon paper with a multiporous layer was then attached to the exposed surface of each electrode to provide a MEA comprising, in order, a GDL, cathode comprising electrode second and first layers, PEM, anode and GDL.

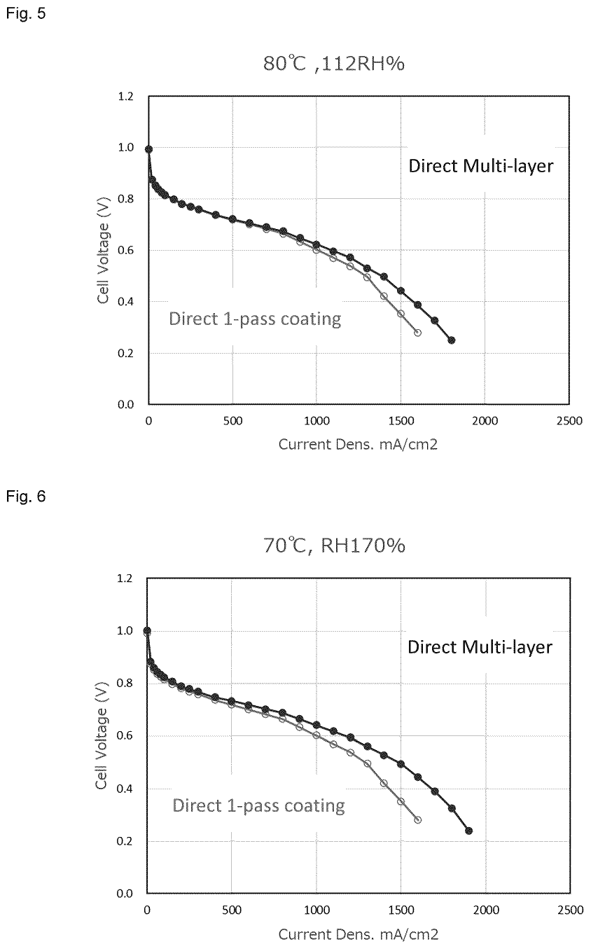

FIGS. 5 and 6 show plots of cell voltage versus current density for cells containing the membrane electrode assemblies of Comparative Example 1 and Example 1 at different relative humidities. Comparative Example 1 applies each electrode in two coating steps from two identical electrode compositions, while Example 1 applies each electrode in two coating steps from electrode compositions in which the weight ratio of the ion exchange material to catalyst support in the electrode first composition deposited in in contact with the electrolyte membrane is higher than the weight ratio of the ion exchange material to catalyst support in the electrode second composition that is deposited on top of the electrode first composition.

It is apparent from FIGS. 5 and 6 that the two-step electrode deposition process described herein provides electrodes which outperform those with a similar overall catalyst loading deposited from identical electrode compositions in two coating steps, in terms of providing a higher cell voltage for a given current density, particularly in the mass transport region of operation above about 750 mA/cm², especially above 1000 mA/cm². Furthermore, the improvement in cell voltage is maintained at increasing relative humidity, as shown in FIG. 6, which plots the data at 170% RH, compared to that of FIG. 5, in which the relative humidity was 112%.

### Comparative Example 2 (“Direct 1-pass”), Comparative Example 3 (“ML 1^{st}”) and Example 2

The electrode compositions of Comparative Example 2, Comparative Example 3 and Example 2 were prepared by combining a platinum catalyst supported on carbon (TEC10F50E-HT from Tanaka Kikinzoku Kogyo K K., Japan) and a perfluorosulfonic acid ion exchange material (Asahi Glass Co., Ltd, Japan) and liquid carrier comprising 1-propanol and distilled water to provide electrode compositions. The proportions of ionomer to carbon catalyst support, first and second electrode compositions (‘1st layer’ ‘ink’ and ‘2nd layer’ ‘ink’) and catalyst loading (by weight of Pt catalytic component) for the electrode compositions are shown in Table 2 below. The electrode compositions were mixed by supersonic homogenizer (UP200S, Hielscher) at 60° C. for 2 minutes to disperse the catalyst. The ratio of ion exchange material to catalyst was determined the thermogravimetric analysis after drying the compositions at 140° C. for 12 hours in an air oven and then grinding in an electric grinder to reduce the particle size to less than 1 mm.

### Comparative Example 2 (“Direct Coating 1-Pass” or “DC 1-Pass”)

A polymer electrolyte membrane comprising a perfluorosulfonic acid ionomer reinforced with an ePTFE microporous support and a PEM thickness of about 15 to 18 microns (commercially available from W. L. Gore & Associates, Inc.) was provided. A slot die was used to apply (coating width 54 mm) a single layer of the electrode composition (Table 2, “1^{st} layer ink”) to the surface of the PEM. The slot dye was in liquid connection with a pump commercially available as a syringe pump 200 series (KDS Legato from Sigma Aldrich) to supply the electrode first composition at a flowrate of 4.46 ml/min. The layer of electrode first composition was then dried by hot air oven at 60° C. for two minutes to provide a cathode electrode in contact with the surface of the PEM.

### Comparative Example 3 (“ML 1^{st}”)

A polymer electrolyte membrane comprising a perfluorosulfonic acid ionomer reinforced with an ePTFE microporous support and a PEM thickness of about 15 to 18 microns (commercially available by W. L. Gore & Associates, Inc.) was provided. A slot die was used to apply (coating width 54 mm) a layer of the electrode composition (Table 2, “1^{st} layer ink”) to the surface of the PEM. The slot dye was in liquid connection with a pump commercially available as a syringe pump 200 series (KDS Legato from Sigma-Aldrich)to supply the electrode first composition at a flowrate of 4.46 ml/min. The layer of electrode composition was then dried by hot air oven at 60° C. for two minutes to provide an electrode first layer in contact with the surface of the PEM.

A slot die was used to apply (coating width 54 mm) a layer of the same electrode composition (Table 2, “2^{nd} layer ink”) to the surface of the dried electrode first layer. The slot dye was in liquid connection with a pump commercially available as a syringe pump 200 series (KDS Legato from Sigma-Aldrich) to supply the electrode composition at a flowrate of 4.46 ml/min. The layer of the electrode second composition was then dried by hot air oven at 60° C. for two minutes to provide an electrode second layer in contact with the electrode first layer to provide a cathode comprising the electrode first and second layers on the PEM.

### Example 2 (“Direct Multilayer”)

A polymer electrolyte membrane comprising a perfluorosulfonic acid ionomer reinforced with an ePTFE microporous support and a PEM thickness of about 15 to 18 microns (commercially available by W. L. Gore & Associates, Inc.) was provided. A slot die was used to apply (coating width 54 mm) a layer of the electrode first composition (Table 2, “1^{st} layer ink”) to the surface of the PEM. The slot dye was in liquid connection with a pump commercially available as a syringe pump 200 series (KDS Legato from Sigma-Aldrich)to supply the electrode first composition at a flowrate of 4.46 ml/min. The layer of electrode first composition was then dried (by hot air oven) at 60° C. for two minutes to provide an electrode first layer in contact with the surface of the PEM.

A slot die was used to apply (coating width 54 mm) a layer of the electrode second composition (Table 2, “2^{nd} layer ink”) to the surface of the dried electrode first layer. The slot dye was in liquid connection with a pump commercially available as a syringe pump 200 series (KDS Legato from Sigma-Aldrich) to supply the electrode second composition at a flowrate of 4.46 ml/min. The layer of the electrode second composition was then dried by hot air oven at 60° C. for two minutes to provide an electrode second layer in contact with the electrode first layer to provide a cathode comprising the electrode first and second layers on the PEM.

An anode was then applied to the side of the PEM opposite to that of the cathode by hot pressing in the MEA components of Comparative Example 2, Comparative Example 3 and Example 2. A gas diffusion layer comprising carbon paper with a multiporous layer was then attached to the exposed surface of each electrode to provide a MEA comprising, in order, a GDL, cathode comprising electrode second and first layers, PEM, anode and GDL.

TABLE 2

| | | | | DC | ML | Direct |
|---|---|---|---|---|---|---|
| | | | unit | 1Pass | 1st | Mutilayer |
| 1st layer | Ink | Pt | wt % | 5% | 5% | 6% |
| (PEM | | Carbon | wt % | 5% | 5% | 6% |
| side) | | IEM | wt % | 6% | 6% | 6% |
| | | Distilled water | wt % | 21% | 21% | 46% |
| | | 1-Propanol | wt % | 64% | 64% | 36% |
| | Solid | IEM/C | wt ratio | 1.2 | 1.2 | 2.00 |
| | | Pt loading | mg/cm2 | 0.4 | 0.2 | 0.08 |
| | | Carbon | mg/cm2 | 0.4 | 0.2 | 0.08 |
| | | IEM | mg/cm2 | 0.48 | 0.24 | 0.16 |
| | | Pt | wt % | 31% | 31% | 25% |
| | | Carbon | wt % | 31% | 31% | 25% |
| | | IEM | wt % | 38% | 38% | 50% |
| 2nd layer | Ink | Pt | wt % | | 5% | 6% |
| (GDL | | Carbon | wt % | | 5% | 6% |
| side) | | IEM | wt % | | 6% | 6% |
| | | Distilled water | wt % | | 21% | 46% |
| | | 1-Propanol | wt % | | 64% | 36% |
| | Solid | IEM/C | wt ratio | | 1.2 | 0.90 |
| | | Pt loading | mg/cm2 | | 0.2 | 0.32 |
| | | Carbon | mg/cm2 | | 0.2 | 0.32 |
| | | IEM | mg/cm2 | | 0.2 | 0.29 |
| | | Pt | wt % | | 31% | 34% |
| | | Carbon | wt % | | 31% | 34% |
| | | IEM | wt % | | 38% | 31% |

* IEM/C is the weight ratio of IEM to carbon catalyst support

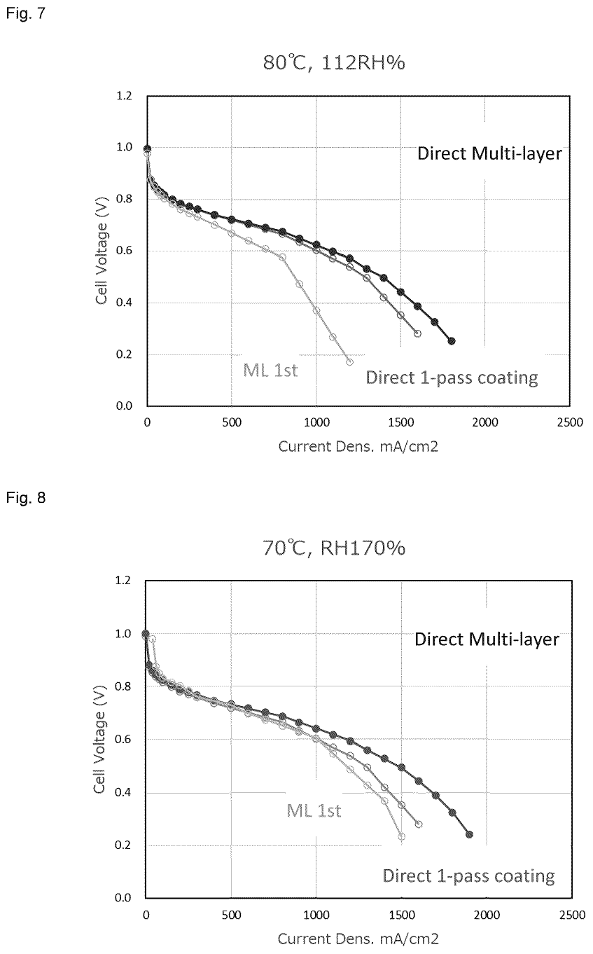

FIGS. 7 and 8 show plots of cell voltage versus current density for cells containing the membrane electrode assemblies of Comparative Example 2 (“Direct 1-pass”), Comparative Example 3 (“ML 1^{st}”) and Example 2 at different relative humidities. Comparative Example 2 applies the cathode in a single coating step, Comparative Example 3 applies the cathode in two coating steps using identical electrode first and second compositions, while Example 2 applies the cathode in two coating steps from electrode compositions in which the weight ratio of the ion exchange material to catalyst support in the electrode first composition deposited in in contact with the electrolyte membrane is higher than the weight ratio of the ion exchange material to catalyst support in the electrode second composition that is deposited on top of the electrode first composition, with intermediate drying of the layer of the first electrode first composition.

It can be seen that while applying two identical electrode coating compositions in Comparative Example 3 provides a lower cell voltage than the electrode formed from a single coating step in Comparative Example 2, applying two electrode compositions in which the second electrode composition has a lower ratio of ion exchange material to catalyst provides improved performance in terms of cell voltage for a given current density.

It is apparent from FIGS. 7 and 8 that the two-step electrode deposition process described herein provides electrodes which outperform those with a similar overall catalyst loading deposited in a single direct coating step (Comparative Example 2) or two coating steps using identical electrode compositions (Comparative Example 3), in terms of providing a higher cell voltage for a given current density, particularly in the mass transport region above about 1000 mA/cm². Furthermore, the improvement in cell voltage is maintained at increasing relative humidity, as shown in FIG. 8, which plots the data at 170% RH, compared to that of FIG. 7, in which the relative humidity was 112%.

While the present disclosure has been described in detail, modifications within the spirit and scope of the disclosure will be readily apparent to the skilled artisan. It should be understood that aspects of the disclosure and portions of various embodiments and various features recited above and/or in the appended claims may be combined or interchanged either in whole or in part. In the foregoing descriptions of the various embodiments, those embodiments which refer to another embodiment may be appropriately combined with other embodiments as will be appreciated by the skilled artisan. Furthermore, the skilled artisan will appreciate that the foregoing description is by way of example only, and is not intended to limit the disclosure.

1. A process for the manufacture of a membrane electrode assembly component, said process comprising:
providing an electrolyte membrane, a first electrode first composition, and a first electrode second composition;
the first electrode first composition comprising an ion exchange material, a liquid carrier and a first catalyst comprising a first catalytic component and a first catalyst support, the first electrode second composition comprising the ion exchange material, the liquid carrier and the first catalyst comprising the first catalytic component and the first catalyst support, wherein
a weight ratio of the ion exchange material to the first catalyst support in the first electrode first composition is greater than a weight ratio of the ion exchange material to the first catalyst support in the first electrode second composition;
applying the first electrode first composition to a first side of the electrolyte membrane to provide a layer of the first electrode first composition having a first side in contact with the first side of the electrolyte membrane;
applying the first electrode second composition to the same side of the electrolyte membrane as the first electrode first composition to provide a layer of the first electrode second composition;
heating the layer of the first electrode first composition and the layer of the first electrode second composition on the electrolyte membrane to remove the liquid carrier from the first electrode first composition and the first electrode second composition to provide a first electrode on the electrolyte membrane, wherein the first electrode comprises the first catalyst and the ion exchange material, to produce a membrane electrode assembly component comprising the first electrode and the electrolyte membrane.

2. The process as claimed in claim 1, wherein the applying of the first electrode second composition applies the first electrode second composition to a second side of the layer of the first electrode first composition opposite to that of the first side of the layer of the first electrode first composition to provide a layer of the first electrode second composition having a first side in contact with the second side of the layer of the first electrode first composition and
the heating the layer of the first electrode first composition and the layer of the first electrode second composition on the electrolyte membrane to remove liquid carrier from the first electrode first composition and the first electrode second composition to provide a first electrode on the electrolyte membrane is a single heating step.

3. The process as claimed in claim 1, wherein the heating of the layer of the first electrode first composition on the electrolyte membrane is a first heating to remove liquid carrier from the first electrode first composition to provide a first electrode first layer on the electrolyte membrane;
the first heating is carried out before the first electrode second composition is applied to the same side of the electrolyte membrane as the first electrode first composition such that applying the first electrode second composition to the same side of the electrolyte membrane as the first electrode first composition applies the first electrode second composition to a second side of the first electrode first layer opposite to that of a first side of the first electrode first layer which is in contact with the first side of the electrolyte membrane to provide a layer of the first electrode second composition having a first side in contact with the second side of the first electrode first layer; and
the heating of the layer of the first electrode second composition is a second heating to remove liquid carrier from the first electrode second composition to provide a first electrode second layer on the second side of the first electrode first layer to provide a first electrode comprising the first electrode first layer and the first electrode second layer.

4. The process as claimed in claim 1, wherein the process is a process for the manufacture of a membrane electrode assembly, the process further comprising:
providing a second electrode first composition, and a second electrode second composition;
the second electrode first composition comprising the ion exchange material, the liquid carrier and a second catalyst comprising a second catalytic component and a second catalyst support,
the second electrode second composition comprising the ion exchange material, the liquid carrier and the second catalyst comprising the second catalytic component and the second catalyst support, wherein
a weight ratio of the ion exchange material to the second catalyst support in the second electrode first composition is greater than a weight ratio of the ion exchange material to the second catalyst support in the second electrode second composition;
applying the second electrode first composition to a second side of the electrolyte membrane, the second side of the electrolyte membrane opposite to that of the first side of the electrolyte membrane, to provide a layer of the second electrode first composition having a first side in contact with the second side of the electrolyte membrane;
applying the second electrode second composition to the same side of the electrolyte membrane as the second electrode first composition to provide allayer of the second electrode second composition;
heating the layer of the second electrode first composition and the layer of the second electrode second composition on the electrolyte membrane to remove liquid carrier from the second electrode first composition and second electrode second composition to provide a second electrode on the electrolyte membrane, wherein the second electrode comprises the second catalyst and the ion exchange material, to produce a membrane electrode assembly comprising, in order, the first electrode, the electrolyte membrane, and the second electrode.

5. The process as claimed in claim 4, wherein the applying of the second electrode second composition applies the second electrode second composition to a second side of the layer of the second electrode first composition opposite to that of the first side of the layer of the second electrode first composition to provide a layer of the second electrode second composition having a first side in contact with the second side of the layer of the second electrode first composition and
the heating the layer of the second electrode first composition and the layer of the second electrode second composition on the electrolyte membrane to remove liquid carrier from the second electrode first composition and the second electrode second composition to provide a second electrode on the electrolyte membrane is a single heating step.

6. The process as claimed in claim 4, wherein the heating of the layer of the second electrode first composition on the electrolyte membrane is a first heating to remove liquid carrier from the second electrode first composition to provide a second electrode first layer on the electrolyte membrane;
the first heating is carried out before the second electrode second composition is applied to the same side of the electrolyte membrane as the second electrode first composition such that applying the second electrode second composition to the same side of the electrolyte membrane as the second electrode first composition applies the second electrode second composition to a second side of the second electrode first layer opposite to that of a first side of the second electrode first layer which is in contact with the second side of the electrolyte membrane to provide a layer of the second electrode second composition having a first side in contact with the second side of the second electrode first layer; and
the heating of the layer of the second electrode second composition is a second heating to remove liquid carrier from the second electrode second composition to provide a second electrode second layer on the second side of the second electrode first layer to provide a second electrode comprising the second electrode first layer and the second electrode second layer.

7. The process as claimed in claim 4, wherein a difference between a weight ratio of the ion exchange material to the first catalyst support in the electrode first composition and a weight ratio of the ion exchange material to the second catalyst support in the electrode second composition is at least 0.4;
wherein a weight ratio of the ion exchange material to the first catalyst support in the electrode first composition is in a range of from 1.4 to 2.4, and a weight ratio of the ion exchange material to the second catalyst support in the electrode second composition is in a range of from 0.4 to 1.4.

8. The process as claimed in claim 4, wherein the applying the electrode first and second compositions are independently selected from slot die coating, slide die coating, curtain coating, gravure coating, reverse roll coating, spray coating, knife-over-roll coating, and dip coating;
wherein the heating the layers of the electrode first compositions and the electrode second compositions comprises drying at a temperature in a range of from 60 to 160° C.;
wherein the first electrode and any second electrode are electronically conductive.

9. The process as claimed in claim 1, wherein the liquid carrier comprises water

10. The process as claimed in claim 1, wherein the liquid carrier comprises C₂-C₁₀ alcohol; wherein the C₂-C₁₀ alcohol is selected from the group consisting of ethanol, 1-propanol, 2-propanol, 2-methyl-2-propanol, and combinations thereof.

11. The process as claimed in claim 4, wherein the first or second catalyst support is a carbon particulate;
wherein the first or second catalytic component comprises one or more catalytic components;
wherein the one or more catalytic components is selected from the group consisting of Pt, Ir, Ni, Co, Pd, Ti, Sn, Ta, Nb, Sb, Pb, Mn, Ru and Fe, their oxides, and mixtures thereof.

12. The process as claimed in claim 4, wherein a catalyst loading in the electrode first composition and the electrode second composition of an electrode is substantially the same.

13. The process as claimed in claim 1, wherein the ion exchange material comprises at least one ionomer;
wherein the at least one ionomer comprises a proton conducting polymer,
wherein the proton conducting polymer comprises perfluorosulfonic acid;
wherein the at least one ionomer has a density not lower than about 1.9 g/cc at 0% relative humidity.

14. The process as claimed in claim 1, wherein the electrolyte membrane comprises an ion exchange material;
wherein the ion exchange material of the electrolyte membrane has the same composition as the ion exchange material of the first electrode and any second electrode; or the ion exchange material of the electrolyte membrane has a different composition than the ion exchange material of the first electrode and any second electrode;
wherein the ion exchange material of the electrolyte membrane is a polymer electrolyte membrane and comprises at least one ionomer.

15. The process as claimed in claim 14, wherein the at least one ionomer of the polymer electrolyte membrane has a density not lower than about 1.9 g/cc at 0% relative humidity;
wherein the at least one ionomer of the polymer electrolyte membrane comprises a proton conducting polymer;
wherein the proton conducting polymer of the polymer electrolyte membrane comprises perfluorosulfonic acid.

16. The process as claimed in claim 14, wherein the polymer electrolyte membrane is a reinforced polymer electrolyte membrane and the reinforced polymer electrolyte membrane further comprises a microporous support;

17. The process as claimed in claim 16, wherein the microporous support comprises at least one fluorinated polymer;
wherein the at least one fluorinated polymer is polytetrafluoroethylene (PTFE), poly(ethylene-co-tetrafluoroethylene) (EPTFE), expanded polytetrafluoroethylene (ePTFE), polyvinylidene fluoride (PVDF), expanded polyvinylidene fluoride (ePVDF), expanded poly(ethylene-co-tetrafluoroethylene) (eEPTFE) or mixtures thereof.

18. The process as claimed in claim 17, wherein the fluorinated polymer is expanded polytetrafluoroethylene (ePTFE).

19. The process as claimed in claim 16, wherein the microporous support comprises at least one hydrocarbon polymer;
wherein the at least one hydrocarbon polymer comprises polyethylene, polypropylene, polycarbonate, polystyrene, or mixtures thereof.

20. The process as claimed in claim 6, wherein the first electrode has a first side and an opposite second side, the first side of the first electrode in contact with the first side of the electrolyte membrane, and wherein the process further comprises:
providing a first gas diffusion layer; and
applying the first gas diffusion layer to the second side of the first electrode to provide a membrane electrode assembly comprising, in order, the first gas diffusion layer, the first electrode, the electrolyte membrane and the second electrode.

21. The process as claimed in claim 20, wherein the second electrode has a first side and an opposite second side, the first side of the second electrode in contact with the second side of the electrolyte membrane, and wherein the process further comprises:
providing a second gas diffusion layer; and
applying the second gas diffusion layer to the second side of the second electrode to provide a membrane electrode assembly comprising, in order, the first gas diffusion layer, the first electrode, the electrolyte membrane, the second electrode and the second gas diffusion layer, wherein the first or second gas diffusion layer comprises a porous carbon particle layer, such as microporous carbon paper.

22. The process as claimed in claim 9, wherein water is present in the electrode first composition or the electrode second composition in an amount greater than 35 wt. % based on a total weight of the ion exchange material and the liquid carrier in the electrode first or second composition;

23. The process as claimed in claim 10, wherein the C₂-C₁₀ alcohol is present in the electrode first composition or electrode second composition in an amount less than 50 wt. % based on a total weight of the ion exchange material and the liquid carrier in the electrode first or second composition.

24. The process as claimed in claim 4, wherein the first or second catalyst, in terms of a total weight of the first or second catalyst, is present in the electrode first composition or electrode second composition in an amount less than 90 wt. % based on a total weight of the electrode first composition or electrode second composition;
wherein the ion exchange material is present in the electrode first composition or electrode second composition in an amount less than 50 wt. % based on a total weight of the ion exchange material and liquid carrier in the electrode first composition or electrode second composition.

25. A membrane electrode assembly obtained by the process according to claim 4; wherein the membrane electrode assembly is a fuel cell membrane-electrode assembly.

26. A fuel cell obtained by the process according to claim 21.
